(19) United States
(12) Patent Application Publication
(10) Pub. No.: US 2016/0294016 A1
(43) Pub. Date: Oct. 6, 2016

(54) NONAQUEOUS SECONDARY BATTERY, MANUFACTURING METHOD THEREOF AND ELECTROLYTE

(71) Applicants: TOKYO OHKA KOGYO CO., LTD., Kawasaki-shi (JP); TOKYO METROPOLITAN UNIVERSITY, Tokyo (JP)

(72) Inventors: Takahiro ASAI, Kawasaki-shi (JP); Kiyoshi KANAMURA, Kawasaki-shi (JP); Hirokazu MUNAKATA, Kawasaki-shi (JP); Shigenori INOUE, Tokyo (JP)

(21) Appl. No.: 15/084,055

(22) Filed: Mar. 29, 2016

(30) Foreign Application Priority Data
Mar. 31, 2015 (JP) 2015-072875

(51) Int. Cl. H01M 10/0585; H01M 10/0567; H01M 10/0562; H01M 10/0525

(52) U.S. Cl. CPC H01M 10/0585; H01M 10/0525; H01M 10/0567; H01M 10/0562; H01M 2220/30

(57) ABSTRACT

A nonaqueous secondary battery, a manufacturing method thereof, and an electrolyte. The battery includes a positive electrode, a negative electrode, a substrate and an electrolyte, in which respective end surfaces of the positive electrode and the negative electrode face each other at a distance, the positive electrode and the negative electrode are arranged in substantially the same plane, the substrate fixingly supports the positive electrode and the negative electrode, the electrolyte is present between the facing end surfaces of the positive electrode and the negative electrode, the electrolyte is involved in a battery reaction between the positive electrode and the negative electrode, and the electrolyte contains ion conductive inorganic solid electrolyte particles and a liquid electrolyte component.

This application claims priority to Japanese Patent Application No. 2015-072875, filed Mar. 31, 2015, the content of which is incorporated herein by reference.

### BACKGROUND OF THE INVENTION

1. Field of the Invention

The present invention relates to a nonaqueous secondary battery, a manufacturing method thereof and an electrolyte.

2. Related Art

Along with the trend in recent years toward development of a microdevice even smaller than a small-sized device such as a portable telephone, a nonaqueous secondary battery in the micro-order is now sought after as a power source for such a microdevice. Such a nonaqueous secondary battery is required to be efficiently driven in a limited space inside a microdevice, and therefore the design of a battery is important.

Conventionally, as a thin-type nonaqueous secondary battery, a lithium ion secondary battery including: a laminated body having a planar structure in which a positive current collector, a positive electrode, a separator, a negative electrode, and a negative electrode collector are laminated in this order in a thickness direction; an electrolyte solution; and a battery case housing the laminated body and the electrolyte solution, has been known (for example, Patent Document 1).

Patent Document 1: Japanese Unexamined Patent Application, Publication No. 2012-64569

### SUMMARY OF THE INVENTION

In order to reduce the thickness of a battery of such a structure, a positive electrode, a negative electrode, and the like having a planar structure may be reduced in thickness. However, it is difficult to avoid consequent deterioration in battery performance.

The present invention has been made in view of the above described situation, and an object thereof is to provide a nonaqueous secondary battery that can be reduced in thickness without deterioration in battery performance and a manufacturing method thereof and an electrolyte.

The present inventors have conducted an extensive research to solve the abovementioned problems. As a result, the present inventors have found that the abovementioned problems can be solved by using, in a nonaqueous secondary battery, an electrolyte containing ion conductive inorganic solid electrolyte particles and a liquid electrolyte component, leading to completion of the present invention. Specifically, the present invention provides the following.

According to a first aspect of the present invention, there is provided a nonaqueous secondary battery including a positive electrode and a negative electrode of which end surfaces face each other at a distance and which are arranged in substantially the same plane, a substrate which fixingly supports the positive electrode and the negative electrode, and an electrolyte which is present between the facing end surfaces of the positive electrode and the negative electrode and is involved in a battery reaction between the positive electrode and the negative electrode, the electrolyte containing ion conductive inorganic solid electrolyte particles and a liquid electrolyte component.

According to a second aspect of the present invention, there is provided a manufacturing method of a nonaqueous secondary battery, the method including: an electrode formation step of forming, on a substrate, a positive electrode and a negative electrode of which end surfaces face each other at a distance; and a filling step of filling a gap between the facing end surfaces of the positive electrode and the negative electrode with an electrolyte involved in a battery reaction between the positive electrode and the negative electrode, where the electrolyte contains ion conductive inorganic solid electrolyte particles and a liquid electrolyte component.

According to a third aspect of the present invention, there is provided an electrolyte for a nonaqueous secondary battery that includes a positive electrode and a negative electrode of which end surfaces face each other at a distance and which are arranged in substantially the same plane, a substrate which fixingly supports the positive electrode and the negative electrode and the electrolyte which is present between the facing end surfaces of the positive electrode and the negative electrode and is involved in a battery reaction between the positive electrode and the negative electrode, the electrolyte containing ion conductive inorganic solid electrolyte particles and a liquid electrolyte component.

According to the present invention, a nonaqueous secondary battery which can be reduced in thickness without deterioration in battery performance, a manufacturing method of the nonaqueous secondary battery, and an electrolyte can be provided.

### BRIEF DESCRIPTION OF THE DRAWINGS

FIGS. 1A to 1C are diagrams schematically illustrating a nonaqueous secondary battery in accordance with an embodiment of the present invention, in which FIG. 1A is a perspective view; FIG. 1B is a transverse sectional view illustrating a cross-section taken along line A-A of the nonaqueous secondary battery shown in FIG. 1A; and FIG. 1C is a longitudinal sectional view illustrating a cross-section taken along line B-B of the nonaqueous secondary battery shown in FIG. 1A;

FIG. 2 is a plan view schematically illustrating interdigital electrodes used in a metal ion secondary battery in accordance with the embodiment of the present invention;

FIGS. 3A to 3D are perspective views sequentially illustrating the steps of a manufacturing method of the nonaqueous secondary battery in accordance with the embodiment of the present invention;

FIGS. 4A to 4I are perspective views sequentially illustrating the steps of a manufacturing method of a interdigital electrode used in a lithium ion secondary battery in accordance with the embodiment of the present invention;

FIGS. 5A to 5H show longitudinal sectional views illustrating a first pattern formation method used in the manufacturing method of the interdigital electrode used in the lithium ion secondary battery in accordance with the embodiment of the present invention;

FIGS. 6A to 6I are longitudinal sectional views illustrating a second pattern formation method used in the method for manufacturing the interdigital electrode used in the lithium ion secondary battery in accordance with the embodiment of the present invention;

FIGS. 7A to 7D are perspective views sequentially illustrating the steps of a manufacturing method of a nonaqueous secondary battery in accordance with another embodiment of the present invention;

FIGS. 8A and 8B are graphs showing the rate property and the cycle property of a lithium ion secondary battery in example 2;

FIGS. 9A and 9B are graphs showing the rate property and the cycle property of a lithium ion secondary battery in example 3;

FIGS. 10A and 10B are graphs showing the rate property and the cycle property of a lithium ion secondary battery in example 4;

FIGS. 11A and 11B are graphs showing the rate property and the cycle property of a lithium ion secondary battery in comparative example 1;

FIGS. 12A and 12B are graphs showing the rate property and the cycle property of a lithium ion secondary battery in comparative example 2; and

FIG. 13 is a graph showing the rate property of a lithium ion secondary battery in example 5.

### DETAILED DESCRIPTION OF THE INVENTION

An electrolyte according to the present invention will first be described. The electrolyte contains ion conductive inorganic solid electrolyte particles and a liquid electrolyte component.

### [Ion Conductive Inorganic Solid Electrolyte Particles]

As the ion conductive inorganic solid electrolyte particles, an ion conductive inorganic solid electrolyte particles which has the conductivity of any ion may be used, examples thereof include alkali metal ions such as a lithium ion conductive inorganic solid electrolyte particles and a sodium ion conductive inorganic solid electrolyte particles and in terms of battery performance, the lithium ion conductive inorganic solid electrolyte particles is preferable. In particular, the lithium ion conductive inorganic solid electrolyte particles will be described below.

Examples of the lithium ion conductive inorganic solid electrolyte particles include a Li—La—Ti—O-based material and a Li—La—Zr—O-based material.

As the Li—La—Ti—O-based material, for example, a composite metal oxide represented by Li₃ₚLa_{2/3-p}TiO₃ (0<p<⅔) or a composite metal oxide in which another metal is substituted for part or the whole of a La site or a Ti site of Li₃ₚLa_{2/3-p}TiO₃ may be used. A metal which can be substituted for the La site of the composite metal oxide represented by the chemical formula Li₃ₚLa_{2/3-p}TiO₃ is at least one type of metal selected from a group consisting of Sr, Na, Nd, Pr, Sm, Gd, Dy, Y, Eu, Tb and Ba, and a metal which can be substituted for the Ti site is at least one type of metal selected from a group consisting of Mg, W, Mn, Al, Ge, Ru, Nb, Ta, Co, Zr, Hf, Fe, Cr and Ga. The Li—La—Ti—O-based material may an amorphous or may have a crystal structure such as a perovskite type.

As the Li—La—Zr—O-based material, a composite metal oxide represented by a chemical formula Li₇La₃Zr₂O₁₂ or a composite metal oxide in which another metal is substituted for part or the whole of a La site or a Zr site of Li₇La₃Zr₂O₁₂ may be used. A metal A which can be substituted for the La site of the composite metal oxide represented by the chemical formula Li₇La₃Zr₂O₁₂ is at least one type of metal selected from a group consisting of Y, Nd, Sm and Gd, and a metal M which can be substituted for the Zr site is at least one type of metal selected from a group consisting of Nb and Ta. Specifically, examples of the lithium ion conductive inorganic solid electrolyte particles include a lithium ion conductive inorganic solid electrolyte particles formed of a composite metal oxide having a garnet structure represented by a chemical formula Li_{7-y}La₃₋ₓAₓZr_{2-y}M_{y}O₁₂ (where 0≦x≦3, 0≦y≦2, A is one type of metal selected from a group consisting of Y, Nd, Sm and Gd and M is one type of metal selected from a group consisting of Nb and Ta). More specifically, examples thereof include Li₇La₃Zr₂O₁₂, Li_{7-y}La₃Zr_{2-y}Nb_{y}O₁₂, Li_{7-y}La₃₋ₓYₓZr_{2-y}Nb_{y}O₁₂, Li_{7-y}La₃₋ₓNdₓZr_{2-y}Nb_{y}O₁₂, Li_{7-y}La₃₋ₓSmₓZr_{2-y}Nb_{y}O₁₂, Li_{7-y}La₃₋ₓGdₓZr_{2-y}Nb_{y}O₁₂, Li_{7-y}La₃Zr_{2-y}Ta_{y}O₁₂, Li_{7-y}La₃₋ₓYₓZr_{2-y}Ta_{y}O₁₂, Li_{7-y}La₃₋ₓNdₓZr_{2-y}Ta_{y}O₁₂, Li_{7-y}La₃₋ₓSmₓZr_{2-y}Ta_{y}O₁₂, Li_{7-y}La₃₋ₓGdₓZr_{2-y}Ta_{y}O₁₂.

In the composite metal oxide having the garnet structure represented by the chemical formula Li_{7-y}La₃₋ₓZr_{2-y}M_{y}O₁₂, a potential window indicated by a difference between an oxidation potential and a reduction potential is large, and an excellent electrochemical stability is provided. In particular, in the composite metal oxide, the reduction potential with respect to a Li⁺/Li electrode reaction is more likely to be less than 0 V, and even when charging and discharging are repeated in a lithium-ion secondary battery using a high-capacity material such as Li, Si or Sn in a negative electrode, reduction is unlikely to occur. In the composite metal oxide, the oxidation potential with respect to the Li⁺/Li electrode reaction is more likely to be equal to or more than 4.0 V, and oxidation is unlikely to occur in a range of 4.0 V or less, with the result that in a lithium-ion secondary battery, an electromotive force of at least 4.0 V can easily be obtained.

The content of the ion conductive inorganic solid electrolyte particles is not particularly limited, and in an electrolyte, is preferably 5 to 90 volume %, is more preferably 10 to 70 volume %, is further more preferably 15 to 50 volume % and is particularly preferably 22.5 to 37.5 volume %. When the content falls within such a range, the battery performance of the nonaqueous secondary battery obtained is easily enhanced, and even when a space between the facing end surfaces of the positive electrode and the negative electrode is assumed to be a minute gap, it is easy to fill with the electrolyte or arrange the electrolyte therein. In the present specification, values for volume are based on room temperature (10 to 35° C.)

### [Liquid Electrolyte Component]

The liquid electrolyte component is not particularly limited, and examples thereof include a liquid electrolyte component which contains an organic medium and a support electrolyte salt. Each of the organic medium and the support electrolyte salt can be used singly or can be used by combining two types or more.

### (Organic Medium)

The organic medium is not particularly limited, and examples thereof include a matrix polymer, an ionic liquid and an organic solvent.

In the present specification, the matrix polymer refers to a polymer compound in the liquid electrolyte component, and examples thereof include ethylene glycol ethers.

### Ethylene Glycol Ethers

The ethylene glycol ethers are not particularly limited, and examples thereof include methyl monoglyme, methyl diglyme, methyl triglyme, methyl tetraglyme, methyl pentaglyme, ethyl monoglyme, ethyl diglyme, ethyl triglyme, ethyl tetraglyme and ethoxymethoxyethane. When the ethylene glycol ethers are used, the ionic conductivity of the liquid electrolyte component is easily enhanced. The ethylene glycol ethers can be used singly or can be used by combining two types or more.

Among them, ethylene glycol ethers are preferable in which the value of n indicating the number of repetitions (chain length) of ethylene oxide chain (CH₂CH₂O)ₙ, is 1 to 4. Specifically, these are ones obtained by omitting methyl pentaglyme from the ethylene glycol ethers illustrated above. The ethylene glycol ethers have structural features in which the number of repetitions n, is 1 to 4, the ethylene oxide chain length is small in length and its steric hindrance is low, and thus a metal ion such as a lithium ion is easily coordinated. Hence, an effect of lowering the interaction between the metal ion such as a lithium ion and the matrix polymer is enhanced, with the result that an effect of enhancing the conductivity of the metal ion such as a lithium ion is more significant.

As the ethylene glycol ethers described above, fluorine-containing ethylene glycol ethers in which substitution for at least one fluorine atom is performed may be used. Even when the fluorine-containing ethylene glycol ethers are used, it is possible to obtain the effect of enhancing the conductivity of the metal ion such as a lithium ion. As the fluorine-containing ethylene glycol ethers, fluorine-containing ethylene glycol ethers in which the number of repetitions n, of the ethylene oxide chain is 1 to 4 are preferable. In the fluorine-containing ethylene glycol ethers, since the electronegativity of fluorine atoms is high, the electron donation of ether oxygen is lowered. However, when the number of repetitions n, of the ethylene oxide chain is 1 to 4, the structural features in which the steric hindrance is low and the metal ion such as a lithium ion is easily coordinated are retained. Hence, it is possible to lower the interaction between the metal ion such as a lithium ion and the polymer chain of the matrix polymer.

### Ionic Liquid

The ionic liquid is a molten salt at room temperature. The ionic liquid can be used singly or can be used by combining two types or more. As the ionic liquid, for example, a compound represented by a general formula (1) or a general formula (A) can be preferably used.

Z⁺-(Ra)ₙX⁻ General formula (1)

In the general formula (1), Z represents, N, S or P, and when Z is N or P, n=4 whereas when Z is S, n=3. Ra presents the same or different alkyl group which may have a substituent and may form a ring together with Z, X represents N(CF₃SO₂)₂, N(CF₃CF₂SO₂)₂, N(SO₂F)₂, BF₄Y, BF₃Y or N(CN)₂ and Y represents an alkyl group or a perfluoroalkyl group.

In the general formula (1) described above, examples of the group represented by Ra include a methyl group, an ethyl group, an i-propyl group, a hydroxyethyl group, a stearyl group, a dodecyl group, an eicosyl group, a docosyl group and an oleyl group, examples of the ring formed together with Z include a pyrrolidine ring, a piperidine ring, a morpholine ring, a tetrahydrothiophene ring and a 1-methyl-phosphorane ring, they may have a substitute, the substitute is not particularly limited and examples thereof include alkyl groups (such as a methyl group, an ethyl group, an i-propyl group, a hydroxyethyl group, a stearyl group, a dodecyl group, an eicosyl group, a docosyl group and an oleyl group), cycloalkyl groups (such as a cyclopropyl group and a cyclohexyl group), aryl groups (such as a phenyl group, a p-tetradecanol oxyphenyl group, o-octadecadienoic amino phenyl group, a naphthyl group and a hydroxyphenyl group), a hydroxyl group, a carboxyl group, a nitro group, a trifluoromethyl group, amide groups (such as an acetamid group and a benzamid group), carbamoyl groups (such as methylcarbamoyl group, butylcarbamoyl group and phenylcarbamoyl group), ester groups (such as an ethyloxycarbonyl group, an i-propyl oxycarbonyl group and a phenyloxycarbonyl group), carbonyloxy groups (such as a methyl carbonyloxy group, a propyl carbonyloxy group and a phenyl carbonyloxy group), a cyano group, halogen atoms (such as chlorine, bromine, iodine and fluorine), alkoxy groups (such as a methoxy group, an ethoxy group and a butoxy group), aryloxy groups (such as a phenoxy group and a naphthyloxy group), sulfonyl groups (such as a methanesulfonyl group and a p-toluenesulfonyl group), alkylthio groups (such as a methylthio group, an ethylthio group and a butylthio group), arylthio groups (such as a phenylthio group), sulfonamide groups (such as a methanesulfonamide group, a dodecyl sulfonamide group and a p-toluenesulfonamide group), sulfamoyl groups (such as a methyl sulfamoyl group and a phenylsulfamoyl group), an amino group, alkylamino groups (such as an ethylamino group, a dimethylamino group and a hydroxyamino group) and arylamino groups (such as a phenylamino group and a naphthylamino group). X represents N(SO₂F)₂, BF₃Z or N(CN)₂, Z represents an alkyl group or a perfluoroalkyl group, examples of the alkyl group include a methyl group, an ethyl group, an i-propyl group, a hydroxyethyl group, a stearyl group, a dodecyl group, an eicosyl group, a docosyl group and an oleyl group and examples of the perfluoroalkyl group include a trifluoromethyl group, a pentafluoroethyl group, a heptafluoropropyl group and a nonafluorobutyl group. N(SO₂F)₂ is preferable.

Among the general formula (1) described above, a compound represented by a general formula (2) below is further preferably used.

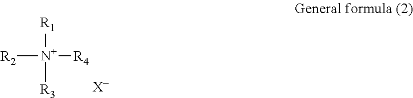

In the general formula (2), R₁ to R₄ represent alkyl groups which may have a substituent, any two groups of R₁ to R₄ may form a ring together with a nitrogen atom, X represents N(CF₃SO₂)₂, N(CF₃CF₂SO₂)₂, N(SO₂F)₂, BF₄Y, BF₃Y or N(CN)₂ and Y represents an alkyl group or a perfluoroalkyl group.

In the general formula (2), examples of the alkyl group represented by R₁ to R₄ include a methyl group, an ethyl group, an i-propyl group, a hydroxyethyl group, a stearyl group, a dodecyl group, an eicosyl group, a docosyl group and an oleyl group, and examples of the ring formed by any two groups of R₁ to R₄ together with a nitrogen atom include a pyrrolidine ring, a piperidine ring and a morpholine ring and they may have a substitute. The substitute is not particularly limited and examples thereof include alkyl groups (such as a methyl group, an ethyl group, an i-propyl group, a hydroxyethyl group, a stearyl group, a dodecyl group, an eicosyl group, a docosyl group and an oleyl group), cycloalkyl groups (such as a cyclopropyl group and a cyclohexyl group), aryl groups (such as a phenyl group, a p-tetradecanol oxyphenyl group, o-octadecadienoic amino phenyl group, a naphthyl group and a hydroxyphenyl group), a hydroxyl group, a carboxyl group, a nitro group, a trifluoromethyl group, amide groups (such as an acetamid group and a benzamid group), carbamoyl groups (such as methylcarbamoyl group, butylcarbamoyl group and phenylcarbamoyl group), ester groups (such as an ethyloxycarbonyl group, an i-propyl oxycarbonyl group and a phenyloxycarbonyl group), carbonyloxy groups (such as a methyl carbonyloxy group, a propyl carbonyloxy group and a phenyl carbonyloxy group), a cyano group, halogen atoms (such as chlorine, bromine, iodine and fluorine), alkoxy groups (such as a methoxy group, an ethoxy group and a butoxy group), aryloxy groups (such as a phenoxy group and a naphthyloxy group), sulfonyl groups (such as a methanesulfonyl group and a p-toluenesulfonyl group), alkylthio groups (such as a methylthio group, an ethylthio group and a butylthio group), arylthio groups (such as a phenylthio group), sulfonamide groups (such as a methanesulfonamide group, a dodecyl sulfonamide group and a p-toluenesulfonamide group), sulfamoyl groups (such as a methyl sulfamoyl group and a phenylsulfamoyl group), an amino group, alkylamino groups (such as an ethylamino group, a dimethylamino group and a hydroxyamino group) and arylamino groups (such as a phenylamino group and a naphthylamino group).

X represents N(SO₂F)₂, BF₃Z or N(CN)₂, Z represents an alkyl group or a perfluoroalkyl group, examples of the alkyl group include a methyl group, an ethyl group, an i-propyl group, a hydroxyethyl group, a stearyl group, a dodecyl group, an eicosyl group, a docosyl group and an oleyl group and examples of the perfluoroalkyl group include a trifluoromethyl group, a pentafluoroethyl group, a heptafluoropropyl group and a nonafluorobutyl group. N(SO₂F)₂ is preferable.

Specific examples of the compound represented by the general formula (1) are shown.

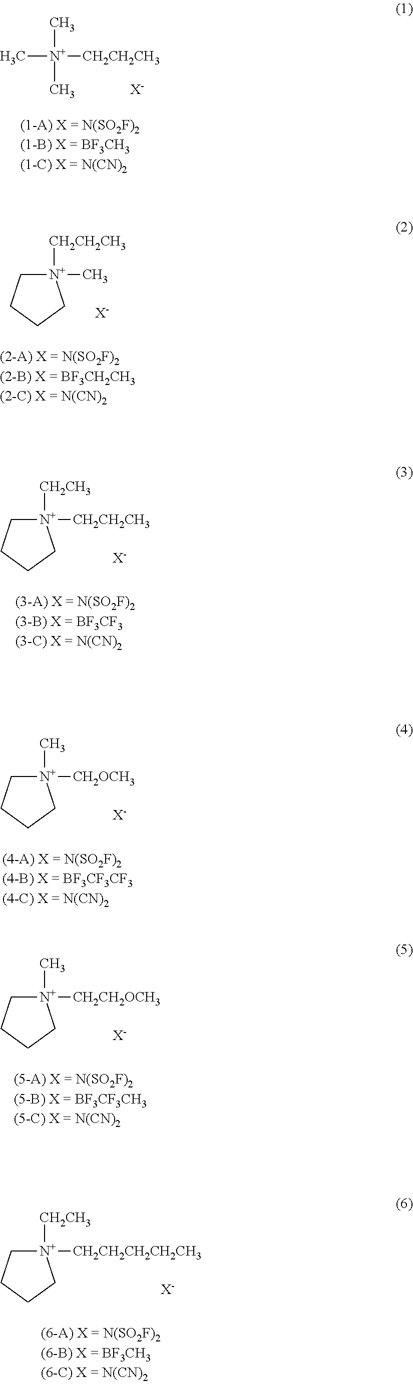

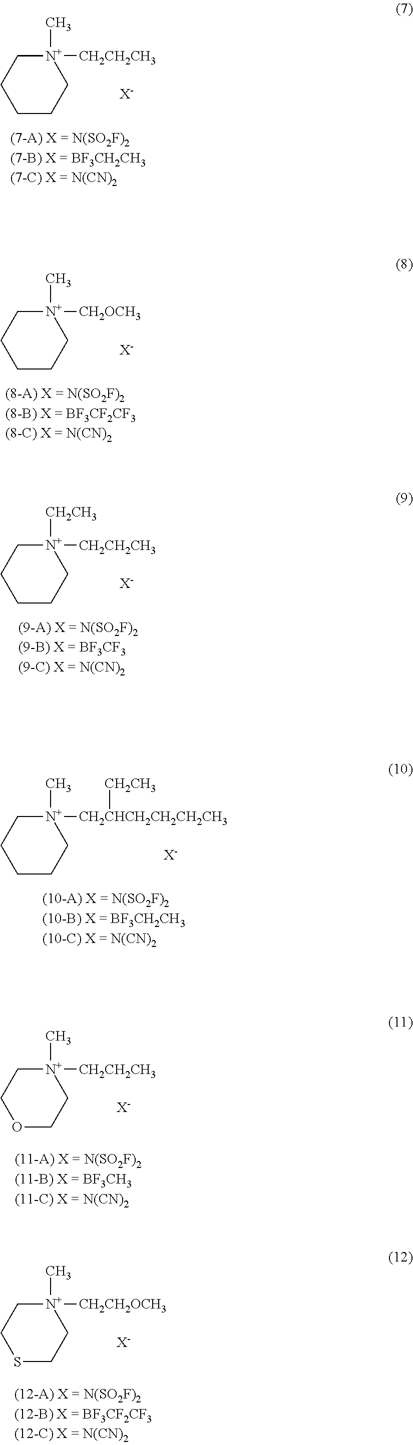

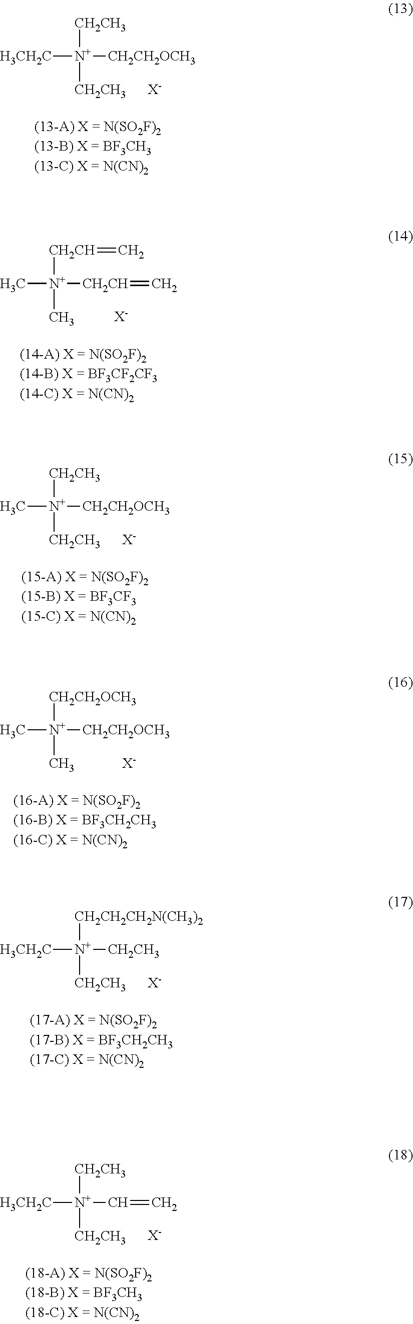

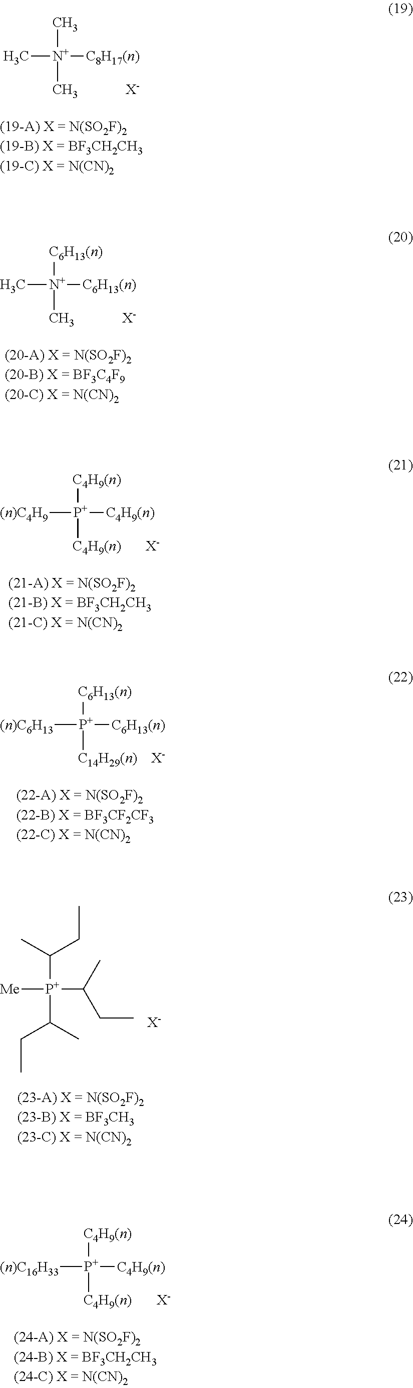

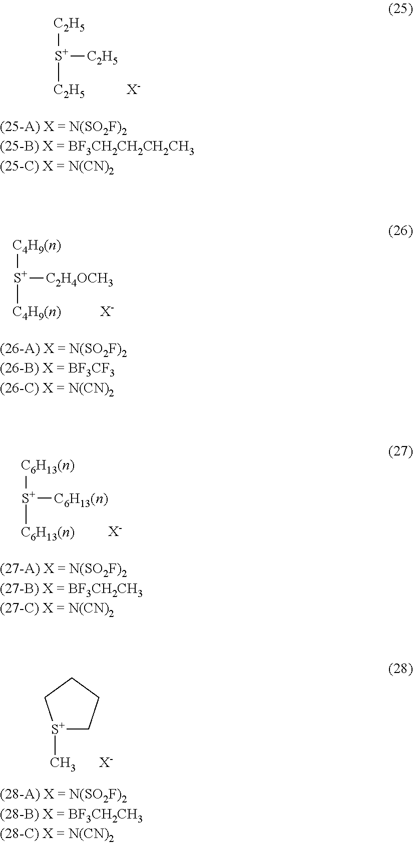

The ionic liquid is preferably a liquid at about room temperature (25° C.). The melting points of these compounds are preferably equal to or less than 80° C., are more preferably equal to or less than 60° C. and are further preferably equal to or less than 30° C.

Furthermore, as the ionic liquid, a compound represented by a general formula (A) below can be preferably used.

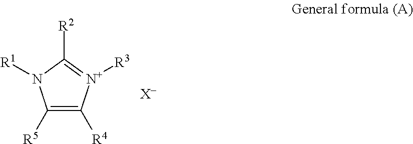

In the general formula (A), R₁ and R₃ represent a hydrocarbon group which may have a substitute and which has 1 to 20 carbon atoms, each of R2, R4 and R5 represents a hydrocarbon group which may have a hydroxyl group, an amino group, a nitro group, a cyano group, a carboxyl group, an ether group or an aldehyde group and which has 1 to 10 carbon atoms or a hydrogen atom and X represents any one of chlorine, bromine, iodine, BF₄, BF₃C₂F₅, PF₆, NO₃, CF₃CO₂, CF₃SO₃, (FSO₂)₂N, (CF₃SO₂)₂N, (CF₃SO₂)₃C, (C₂F₅SO₂)₂N, AlCl₄ and Al₂Cl₇.

Specific examples of the compound represented by the general formula (A) include 1-isopropyl-2,3-dimethyl imidazolium bis-trifluoromethanesulfonyl salt, 1-ethyl-2,3-dimethyl imidazolium bis-trifluoromethanesulfonyl salt, 1-butyl-2,3-dimethyl imidazolium bis-trifluoromethanesulfonyl salt, 1-hexyl-2,3-dimethyl imidazolium bis-trifluoromethanesulfonyl salt and 1-octyl-2,3-dimethyl imidazolium bis-trifluoromethanesulfonyl salt, and among them, in terms of conductivity and reduction resistance, 1-isopropyl-2,3-dimethyl imidazolium bis-trifluoromethanesulfonyl salt can be preferably used. Organic solvent

The organic solvent is not particularly limited, and examples thereof include carbonic acid ester compounds such as ethylene carbonate, dimethyl carbonate and diethyl carbonate, octanol such as alcohol and acetonitrile. The organic solvent can be used singly or can be used by combining two types or more.

### (Support Electrolyte Salt)

The support electrolyte salt is a salt which provides ions in a secondary battery electrolyte composition, and a known support electrolyte salt used in a battery can be used. The support electrolyte salt can be used singly or can be used by combining two types or more.

As the support electrolyte salt, an arbitrary one can be used, and the salt of a metal ion belonging to periodic table group 1 or 2 can be preferably used. As the metal ion belonging to periodic table group 1 or 2, the ion of lithium, sodium or potassium is preferable.

Examples of the anion of the salt of the metal ion include halide ions (such as I⁻, Cl⁻ and Br⁻), SCN⁻, (CN)₂N⁻, BF₄⁻, BF₃CF₃⁻, BF₃C₂F₅⁻, PF₆⁻, ClO₄⁻, SbF₆⁻, (FSO₂)₂N⁻, (CF₃SO₂)₂N⁻, (CF₃CF₂SO₂)₂N⁻, Ph₄B⁻(C₂H₄O₂)₂B⁻, (CF₃SO₂)₃CF₃COO⁻, CF₃SO₃⁻ and C₆F₅SO₃⁻.

Among the anions described above, SCN⁻, (CN)₂N⁻, BF₄⁻, BF₃CF₃⁻, BF₃C₂F₅⁻, PF₆⁻, ClO₄⁻, SbF₆⁻, (FSO₂)₂N⁻, (CF₃SO₂)₂N⁻, (CF₃CF₂SO₂)₂N⁻, (CF₃SO₂)₃C⁻ and CF₃SO₃⁻ are more preferable.

Examples of the typical electrolyte salt include LiCF₃SO₃, LiPF₆, LiClO₄, LiI, LiBF₄, LiBF₃CF₃, LiBF₃C₂F₅, LiCF₃CO₂, LiSCN, LiN(SO₂F)₂, LiN(SO₂CF₃)₂, NaI, NaCF₃SO₃, NaClO₄, NaBF₄, NaAsF₆, KCF₃SO₃, KSCN, LiN(CN)₂, KPF₆, KCO₄ and KAsF6. The Li salts described above are further preferable. These may be used singly or may be used by mixing two or more types thereof.

The content of the support electrolyte salt is not particularly limited, and is preferably adjusted such that the concentration of a metal atom (such as a lithium atom or a sodium atom) of the salt is 0.2 to 2.0 M. When the content falls within such a range, the battery performance of the nonaqueous secondary battery obtained is easily enhanced.

Hereinafter, embodiments of the present invention are described in detail with reference to the drawings.

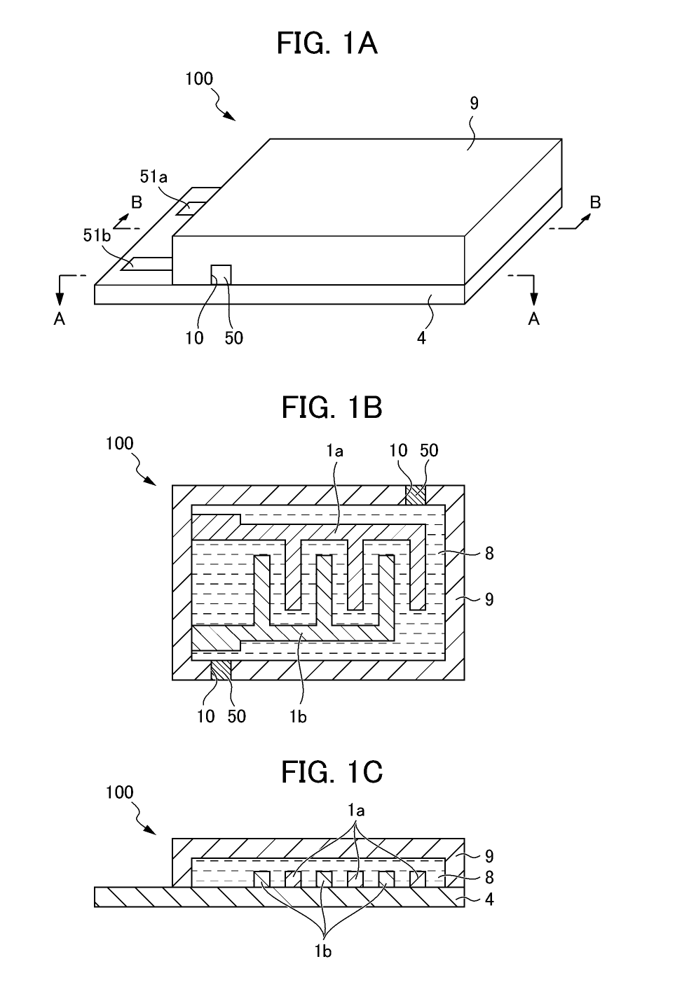

FIGS. 1A to 1C show diagrams schematically illustrating a nonaqueous secondary battery in accordance with an embodiment of the present invention. FIG. 1A is a perspective view; FIG. 1B is a transverse sectional view illustrating a cross-section taken along line A-A of the nonaqueous secondary battery shown in FIG. 1A; and FIG. 1C is a longitudinal sectional view illustrating a cross-section taken along line B-B of the nonaqueous secondary battery shown in FIG. 1A.

Firstly, a nonaqueous secondary battery 100 in accordance with the embodiment of the present invention is briefly described with reference to FIGS. 1A to 1B. In the nonaqueous secondary battery 100, interdigital electrodes 1a and 1b are respectively formed into comb-like shapes, and oppositely disposed so that teeth parts of the comb-like shapes are alternately arranged. Thus, the interdigital electrodes 1a and 1b are disposed such that respective end surfaces thereof face each other at a distance. Herein, the interdigital electrode 1a is a positive electrode, and the interdigital electrode 1b is a negative electrode. Such a configuration of the interdigital electrodes 1a and 1b leads to a shorter distance between the electrodes and a constant electrolyte resistance, and thus exchange of metal ions such as lithium ions and sodium ions can be effectively performed so that battery capacitance can be increased.

Between the interdigital electrode 1a and the interdigital electrode 1b, a space or a separator (not shown) for isolating the electrodes from one another is provided, so that the electrodes are electrically spaced apart from one other. Furthermore, a gap between the interdigital electrode 1a and the interdigital electrode 1b is filled with an electrolyte 8 involved in a battery reaction. The interdigital electrodes 1a and 1b are formed on the surface of a substrate 4 whose surface is a non-conductor, that is, on the same plane. As compared with a conventional nonaqueous secondary battery in which electrode members such as the positive current collector, the positive electrode, the separator, the negative electrode, and the negative electrode collector are laminated in the thickness direction thereof, even when an electrode member having the same thickness as that of a conventional battery is used, the nonaqueous secondary battery in accordance with the embodiment of the present invention can be drastically reduced in thickness (for example, about ⅓).

It should be noted that the interdigital electrodes 1a and 1b may be arranged in substantially the same plane. As used herein, “arranged in substantially the same plane” means that a distance between a plane having the interdigital electrode 1a and a plane having the interdigital electrode 1b is more than 0 μm and not more than 10 μm, and preferably more than 0 μm and not more than 5 μm.

Examples of the substrate 4 include a silicon substrate having an oxide film on the surface thereof. It is preferable that the silicon substrate further has an adhesion imparting layer (described later) on the upper layer of the oxide film.

Furthermore, other examples of the substrate 4 include an insulating substrate or a substrate having an insulating layer, and may include a substrate having transparency or flexibility, for example, a glass substrate, a PET film, a glass film, and the like.

A cover member 9 may be bonded to the substrate 4 so as to cover the interdigital electrodes 1a and 1b. The cover member 9, together with the substrate 4, defines an airtight chamber which contains the interdigital electrodes 1a and 1b. In this case, it is possible to form a nonaqueous secondary battery including: positive electrodes and negative electrodes which are arranged in substantially the same plane such that the end surfaces thereof face each other at a distance; a substrate which fixingly supports the positive electrodes and the negative electrodes; a cover member which defines an airtight chamber including the positive electrodes and the negative electrodes together with the substrate and which has gas barrier properties; and an electrolyte which is stored within the airtight chamber so as to be present at least between the facing end surfaces of the positive electrodes and the negative electrodes and is involved in the battery reaction of the positive electrodes and the negative electrodes. The cover member 9 may have at least gas barrier properties and can be formed of a material having extremely small permeability to gas, in particular, to water vapor, for example, glass, PET, a glass film, SUS (JIS standard symbol of stainless steel material for Steel Special Use Stainless), silicon, or hydrofluoric acid-resistance oxide film made of at least one hydrofluoric acid-resistant inorganic oxide from Al₂O₃, ZrO₂, ZnO, Nb₂O₅, Ta₂O₅, TiO₂ or the like. Specific examples of the cover member 9 include members which have gas barrier properties such as an ethylene-propylene-diene rubber (EPDM rubber). Use of the cover member 9 having at least gas barrier properties easily suppresses the moisture absorption of the electrolyte 8, and thereby makes it easier to prevent deterioration in the nonaqueous secondary battery 100. When the nonaqueous secondary battery 100 is a metal-air secondary battery such as a lithium-air secondary battery, for example, it is preferable that an oxygen occlusion material capable of absorbing and releasing oxygen is provided on the inner side of the cover member 9. When the oxygen occlusion material is provided, charge and discharge can be carried out even if oxygen is not taken in from the outside air, and thus H₂O and CO₂ can be prevented from being mixed into the nonaqueous secondary battery 100.

It is preferable that the cover member 9 further has hydrofluoric acid-resistance. When the electrolyte 8 such as LiPF₆, capable of liberating hydrofluoric acid, is used and even if hydrofluoric acid is actually liberated, the cover member 9 having hydrofluoric acid-resistance can effectively avoid corrosion and dissolution due to hydrofluoric acid. Examples of material having hydrofluoric acid-resistance include PET or the hydrofluoric acid-resistance oxide film. Even when other materials are used, the hydrofluoric acid-resistance can be imparted to the cover member 9 by vapor-depositing, via a known method, a noble metal such as gold or platinum and the hydrofluoric acid-resistant inorganic oxide to, for example, at least a part of the cover member 9 which is brought into contact with the electrolyte 8.

It should be noted that the cover member 9 has a liquid injection hole 10 as described later, and the liquid injection hole 10 is sealed with an adhesive agent 50 in the nonaqueous secondary battery 100. Furthermore, the nonaqueous secondary battery 100 is provided with terminals 51a and 51b on the substrate 4. The terminals 51a and 51b are connected to the interdigital electrodes 1a and 1b, respectively.

The nonaqueous secondary battery 100 is not particularly limited, and examples thereof include a metal ion secondary battery such as a lithium ion secondary battery and a sodium ion secondary battery; a metal secondary battery such as a lithium metal secondary battery; a metal-air secondary battery such as a lithium-air secondary battery, and the like.

It should be noted that in the nonaqueous secondary battery 100, when, for example, a cover member having oxygen permeability is used, as the cover member 9 instead of the cover member having gas barrier properties, as a metal-air secondary battery such as a lithium-air secondary battery, a secondary battery including a positive electrode and a negative electrode arranged in substantially the same plane so that respective end surfaces of the positive electrode and the negative electrode face each other at a distance; a substrate for fixingly supporting the positive electrode and the negative electrode; a cover member having oxygen permeability and defining a housing chamber, which contains the positive electrode and the negative electrode, together with the substrate; and an electrolyte which is housed in the housing chamber so as to be positioned at least between the facing end surfaces of the positive electrode and the negative electrode, and which is involved in a battery reaction between the positive electrode and the negative electrode. The electrolyte can be configured so as to contain the ion conductive inorganic solid electrolyte particles and the liquid electrolyte component.

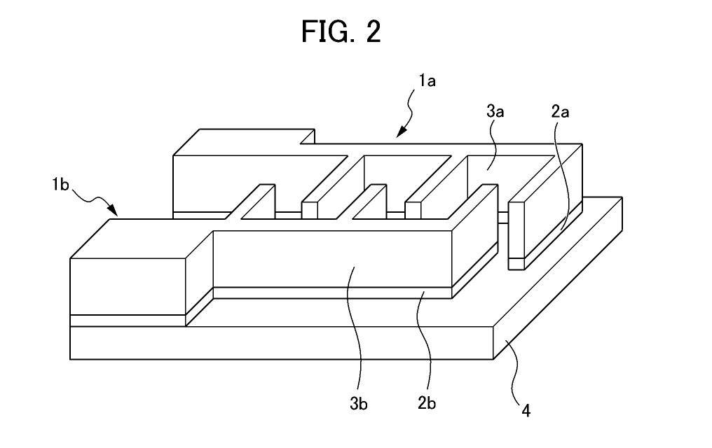

Hereinafter, in particular, a case where the nonaqueous secondary battery 100 is a metal ion secondary battery is described in more detail with reference to FIGS. 1A to 1C and 2.

As shown in FIG. 2, an interdigital electrode 1a as the positive electrode includes a current collector 2a to draw an electric current, and a positive-electrode active material layer 3a formed on a surface of the current collector 2a. The current collector 2a is formed in a comb-like shape in a plan view. The positive-electrode active material layer 3a is formed on the surface of the current collector 2a, that has a comb-like shape seen in a plan view, similar to the current collector 2a having a comb-like shape.

In order to impart conductivity, the current collector 2a is constructed of metal, and the metal may be appropriately selected in consideration of the potential difference between the used positive electrode and negative electrode. The current collector 2a is preferably gold, aluminum, or the like. Then, in order to ensure the adhesion between the current collector 2a and the substrate 4, an adhesion imparting layer (not shown) is formed between the current collector 2a and the substrate 4 as necessary. The adhesion imparting layer is appropriately determined in consideration of the material of the current collector 2a and the material of the substrate 4. As an example, when the current collector 2a is constructed of gold, aluminum, or the like, and the substrate 4 is constructed of silicon, a thin film of titanium is preferably used as the adhesion imparting layer. The thickness of the current collector 2a and the thickness of the adhesion imparting layer may be optionally determined without particular limitation thereto. As an example, the thickness of the current collector 2a is 100 to 500 nm, and the thickness of the adhesion imparting layer is 50 nm to 100 nm, but they are not limited thereto.

The interdigital electrode 1b as a negative electrode has the current collector 2b to draw an electric current and the negative-electrode active material layer 3b formed on the surface of the current collector 2b. The other items of the interdigital electrode 1b are similar to those of the interdigital electrode 1a as the positive electrode, and therefore descriptions thereof are omitted.

As mentioned above, the gap between the interdigital electrode 1a as the positive electrode and the interdigital electrode 1b as the negative electrode is filled with the electrolyte 8. Consequently, the interdigital electrode 1a and the interdigital electrode 1b each cause an electrode reaction, and the current can be drawn from the current collector 2a and the current collector 2b.

The entire size of interdigital electrodes; the thickness, length, and number of teeth in the interdigital electrode 1a or the interdigital electrode 1b; the space between two adjacent teeth; the thickness of active material layers, or the like may be appropriately adjusted depending on the desired charge capacity and discharge capacity. For example, the thickness of teeth may be 10 to 50 μm, the space between two adjacent teeth may be 30 to 70 μm, and the thickness of active material layers may be 10 to 50 μm. It should be noted that when a transparent substrate is used as the substrate 4 and a transparent member is used as the cover member 9, by changing at least one of the thickness of teeth, length of teeth, number of teeth, and space between teeth, the optical transparency of the nonaqueous secondary battery 100 can be appropriately changed. In a region in which the teeth of the interdigital electrode 1a and the interdigital electrode 1b are alternately arranged seen in the direction perpendicular to the direction of the length of teeth in the interdigital electrode 1a and interdigital electrode 1b and in the direction parallel to the substrate 4, an area ratio of a transmission portion to the total area of the teeth of the interdigital electrode 1a, the teeth of the interdigital electrode 1b, and a gap between the teeth of the interdigital electrode 1a and the teeth of the interdigital electrode 1b (transmission portion) is preferably, for example, 40 to 95%.

Material of the positive-electrode active material layer 3a and the negative-electrode active material layer 3b, as well as the type of electrolyte 8, are appropriately determined from those that can be employed for a metal ion secondary battery such as a lithium ion secondary battery and a sodium ion secondary battery. For example, when the metal ion secondary battery is a lithium ion secondary battery, examples of the material to configure the positive-electrode active material layer 3a include a transition metal oxide such as lithium cobaltate; examples of the material to configure the negative-electrode active material layer 3b include carbon, graphite, lithium titanate; and examples of the electrolyte 8 are as described above, and more specifically, examples of the electrolyte 8 include an electrolyte containing the ion conductive inorganic solid electrolyte particles and the liquid electrolyte component (for example, combinations between organic media such as ethylene glycol ethers, an ionic liquid and an organic solvent and lithium salts such as lithium perchlorate, lithium hexafluorophosphate and lithium bis (trifluoromethylsulfonyl) imide.) Furthermore, for example, when the metal ion secondary battery is a sodium ion secondary battery, examples of the material to configure the positive-electrode active material layer 3a include transition metal oxide such as sodium cobaltate; examples of the material to configure the negative-electrode active material layer 3b include carbon, graphite, sodium titanate; and examples of the electrolyte 8 are as described above, and more specifically, examples of the electrolyte 8 include an electrolyte containing the ion conductive inorganic solid electrolyte particles and the liquid electrolyte component (for example, combinations between organic media such as ethylene glycol ethers, an ionic liquid and an organic solvent and sodium salts such as sodium perchlorate, sodium hexafluorophosphate and sodium bis (trifluoromethylsulfonyl) imide.)

More specifically, when the metal ion secondary battery is a lithium ion secondary battery, examples of the active material include particles of positive-electrode active materials such as LiCoO₂, LiFePO₄, and LiMn₂O₄ and particles of negative-electrode active materials such as graphite, Li₄Ti₅O₁₂, Sn alloys, and Si-based compounds. Furthermore, when the metal ion secondary battery is a sodium ion secondary battery, examples of the active material include particles of positive-electrode active materials such as NaCoO₂, NaFePO₄, and NaMn₂O₄, and particles of negative-electrode active materials such as graphite, Na₄Ti₅O₁₂, Sn alloys, and Si-based compounds. When forming the active material layer, preferably, the active material is used in the state of a dispersion liquid where the active material is dispersed in a dispersion medium. The dispersion medium used may be, for example, water, acetonitrile, N-methylpyrrolidone, acetone, ethanol, and the like. Preferably, the amount of the dispersion medium used is an amount that leads to 35 to 60 mass % of solid content concentration in the dispersion liquid.

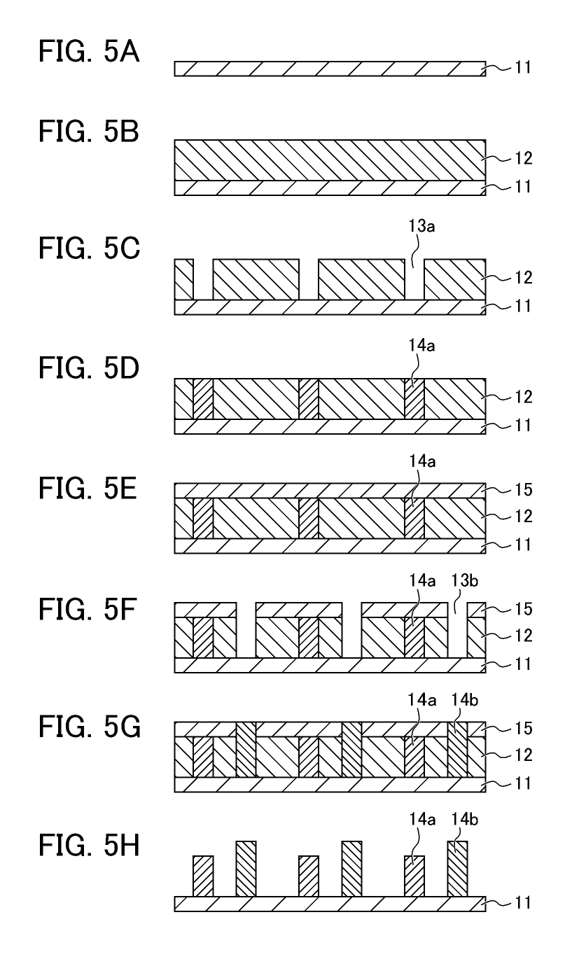

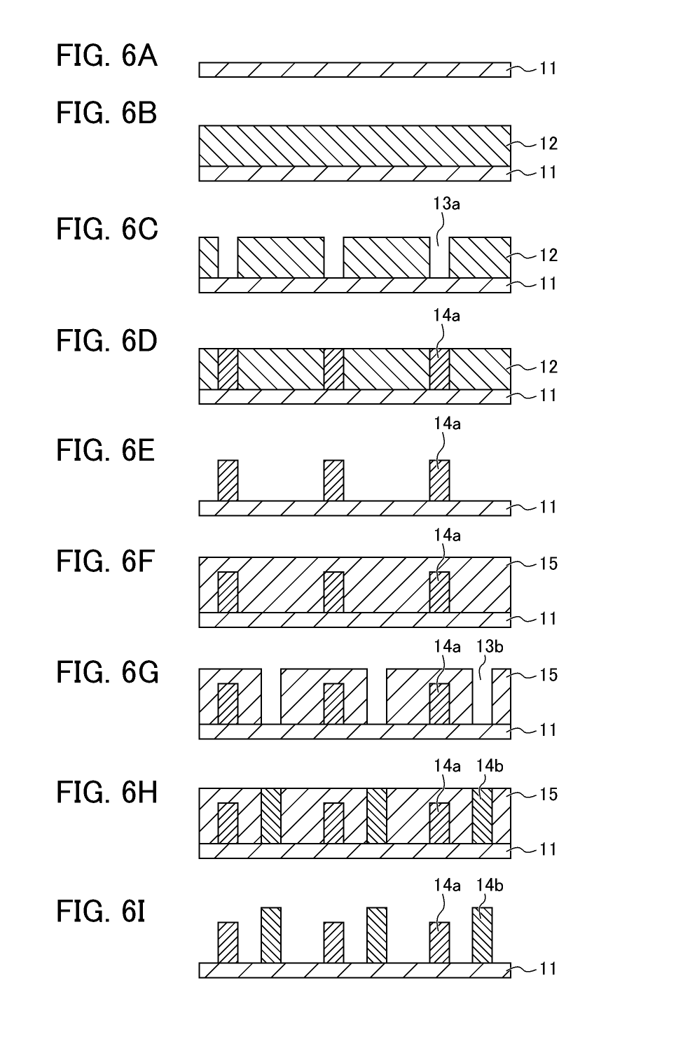

The dispersion liquid typically contains a binder such as styrene-butadiene rubber (SBR) and polyvinylidene fluoride. The dispersion liquid may further contain a conductive aid such as carbon black (for example, acetylene black) and a dispersant such as carboxymethylcellulose. The contents of the active material, binder, conductive aid, and dispersant in the solid content of the dispersion liquid are not particularly limited. In the solid content of the dispersion liquid, the content of the active material is preferably 75 to 99 mass % and more preferably 80 to 98 mass %; the content of the binder is preferably 1 to 15 mass %; the content of the conductive aid is preferably 0 to 9 mass %; and the content of the dispersant is preferably 0 to 7 mass %. Particularly, when the content of the conductive aid is within the above-mentioned range, belt-like residue of active materials extending in a squeegee-moving direction is unlikely to appear on the surface of the resist layer 12 or 15 during filling the guide hole 13a or 13b with the dispersion liquid by a screen printing process in the below-mentioned step shown in FIG. 5D or 5G or FIG. 6D or 6H, and also whisker-like residue of active materials is unlikely to appear in the resulting interdigital electrodes, thereby short circuiting between electrodes can be effectively prevented.

In the electrolyte 8, the content of the salt is preferably adjusted such that the concentration of a metal atom (for example, lithium atom or sodium atom) constituting the salt is 0.2 to 2.0 M. The electrolyte 8 may further contain an additive including unsaturated cyclic carbonate ester compounds such as vinylene carbonate, halogen-substituted carbonate ester compounds such as fluoroethylene carbonate, cyclic sulfonate-based compounds such as 1,3-propane sultone, cyclic sulfite ester compounds such as ethylene sulfite, crown ethers such as 12-crown-4, and aromatic compounds such as benzene and toluene. When the electrolyte 8 contains one of the above additives, operating life of the resulting secondary battery tends to be longer. The concentration of the additive is preferably 0.1 to 20 mass % in the electrolyte 8.

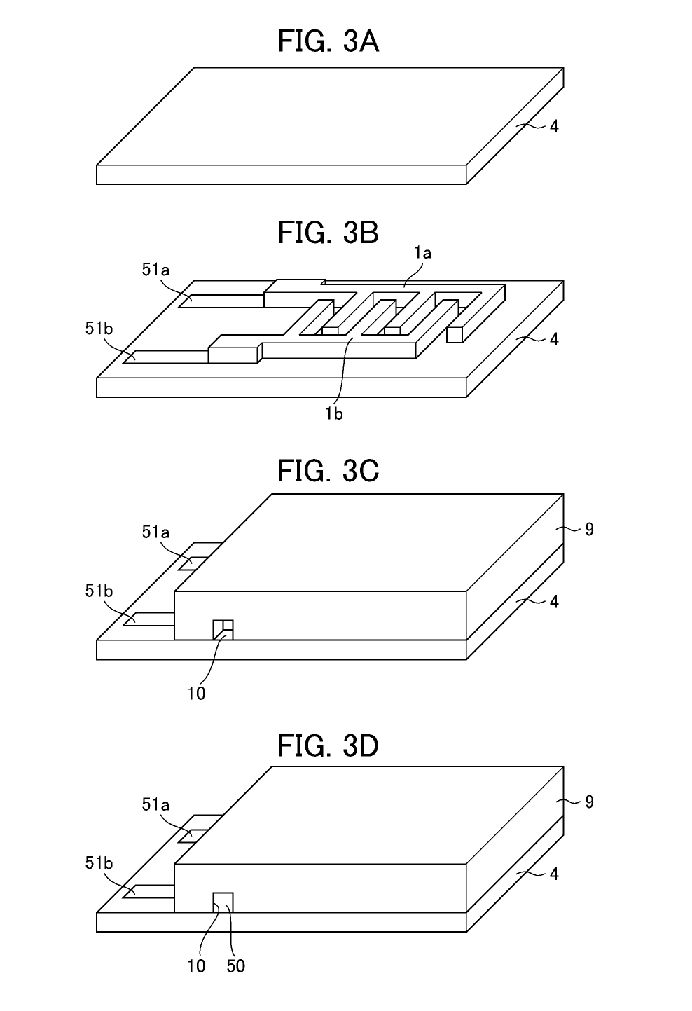

Next, a manufacturing method of the nonaqueous secondary battery 100 in accordance with the embodiment of the present invention is described. The manufacturing method of the nonaqueous secondary battery 100 in accordance with the embodiment includes at least an electrode formation step, a cover member bonding step, and an electrolyte filling step. While the manufacturing method of the nonaqueous secondary battery according to the present invention includes an electrode formation step and a filling step, the manufacturing method of the nonaqueous secondary battery 100 described above further includes the cover member bonding step and includes the electrolyte filling step as the filling step. Hereinafter, each step is described with reference to FIGS. 3A to 3D.

### [Electrode Formation Steps]

Electrode formation steps are steps sequentially shown in FIGS. 3A and 3B.

In this step, interdigital electrodes 1a and 1b are formed on the surface of a substrate 4. Formation of the interdigital electrodes 1a and 1b can be carried out by a well-known method including, for example, a screen printing process, a metal spraying process, a plating process, a vapor deposition method, a sputtering process, an ion plating process, a plasma CVD method, and a combination of two or more of these processes.

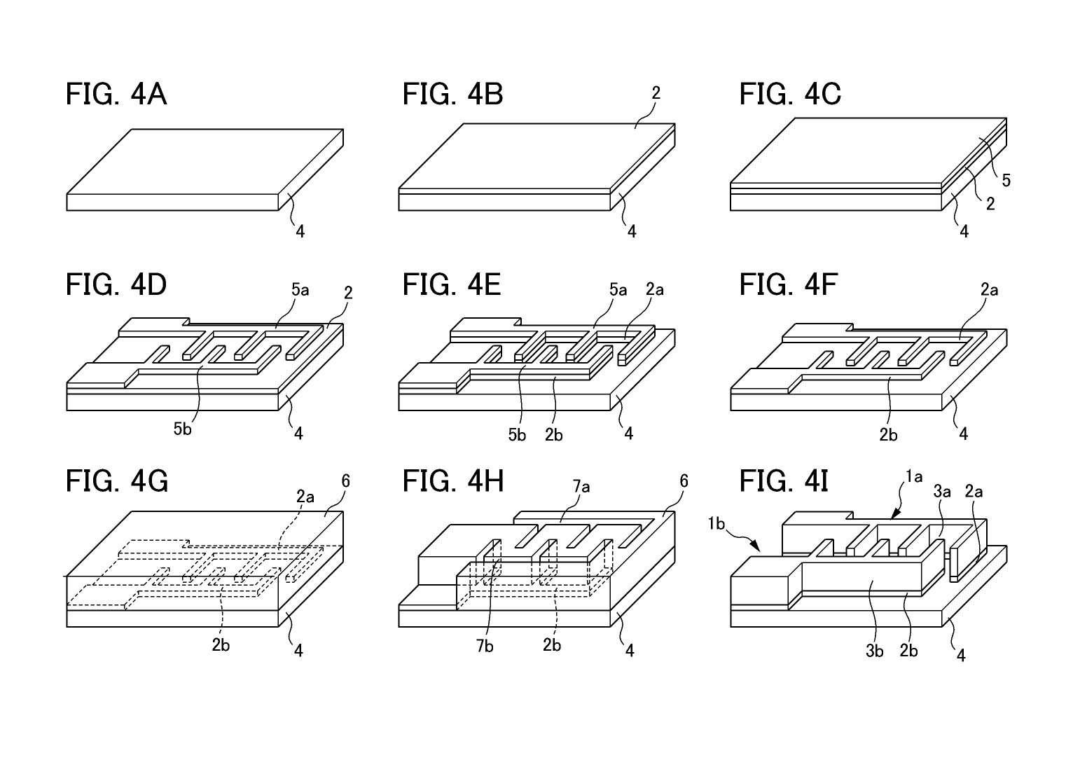

Furthermore, when the nonaqueous secondary battery 100 is a metal ion secondary battery such as a lithium ion secondary battery and a sodium ion secondary battery, it is preferable that the electrode formation step includes a current collector formation step, a resist application step, a guide hole formation step, and an active material layer formation step. Hereinafter, in particular, each step in the electrode formation steps is described with reference to FIGS. 4A to 4I with attention focused on a case where the nonaqueous secondary battery 100 is a lithium ion secondary battery. It should be noted that also when the nonaqueous secondary battery 100 is a metal ion secondary battery other than a lithium ion secondary battery, such as a sodium ion secondary battery, similar to the case where the nonaqueous secondary battery 100 is a lithium ion secondary battery, electrodes can be formed by the electrode formation step including a current collector formation step, a resist application step, a guide hole formation step, and an active material layer formation step mentioned below.

### (Current Collector Formation Step)

Current collector formation steps are steps sequentially shown in FIGS. 4A to 4F.

In this step, firstly, a thin-film conductive layer 2 is formed on the surface of the substrate 4 (FIGS. 4A to 4B). The substrate 4 is a non-conductor or a conductor or semiconductor provided with a non-conductor layer on at least a surface thereof, and examples of the substrate 4 include a silicon substrate having an oxide film on the surface thereof, and also a glass substrate, a PET film, and the like. The conductive layer 2 is a conductor, and preferably a metal thin film. In order to form the conductive layer 2 on the surface of the substrate 4, various well-known processes including a vapor deposition process such as a PVD process or a CVD process, a sputtering process, a plating process, a metal foil adhesion process, and the like can be used. The thickness of the conductive layer 2 may be appropriately determined in consideration of performance required of the electrodes 1a and 1b.

For example, when the substrate 4 is a silicon substrate having an oxide film on the surface thereof, and the conductive layer 2 is formed of a thin film of gold or aluminum, an exemplified method is a method including firstly forming a thin film (not shown) of titanium on the surface of the silicon substrate 4 by the sputtering process, and then forming the thin film of gold or aluminum as the conductive layer 2 on the surface of the thin film of titanium by the sputtering process. In this case, the thin film of titanium is provided in order to improve the adhesion of the conductive layer 2 to the silicon substrate 4. The thicknesses of the thin film of titanium and the conductive layer 2 are, for example, 100 to 500 nm, and the thickness of the adhesion imparting layer is, for example, 50 nm to 100 nm. The thicknesses may be appropriately determined in consideration of required performance.

After the conductive layer 2 is formed, as shown in FIG. 4C, a current collector-formation resist is applied to the surface of the conductive layer 2 so as to form a current collector-formation resist layer 5. The current collector-formation resist layer 5 is provided in order to pattern the conductive layer 2 and to form interdigital current collectors 2a and 2b.

As the current collector-formation resist, well-known various resist compositions can be used. It should be noted that the term “current collector-formation resist” is used to discriminate this resist from a resist used for forming guide holes 7a and 7b mentioned later. The current collector-formation resist may be the same as or different from the resist to be used in a guide hole formation step mentioned later.

Well-known methods may be used for the method for applying the current collector-formation resist, without particular limitation thereto. Such methods include a spin coating process, a dipping process, a brush application process, and the like.

The formed current collector-formation resist layer 5 is selectively exposed and developed through an interdigital mask pattern, and made into resin patterns 5a and 5b for forming the current collector. Thus, as shown in FIG. 4D, the resin patterns 5a and 5b for forming the current collector are formed on the surface of the conductive layer 2. The number of teeth, the thickness of teeth, a gap between the patterns (a space gap), and the like in the interdigital resin patterns 5a and 5b may be appropriately determined in consideration of required performance. The number of teeth may be, for example, 5 to 500 pairs; the thickness of teeth may be, for example, 1 to 50 μm; the space gap may be, for example, 1 to 50 μm, respectively. As an example, the number of teeth is 100 pairs (the number of teeth of one side of the resin pattern is 100), the thickness of teeth is 20 μm, and the space gap is 10 to 20 μm, but these dimensions are not limited thereto.

Next, a part which is not covered with the patterns 5a and 5b of the conductive layer 2 is removed. The conductive layer 2 can be removed by using a well-known method without particular limitation. Examples of such methods include an etching process, an ion milling process, and the like. When the part which is not covered with the patterns 5a and 5b of the conductive layer 2 is removed, the interdigital current collectors 2a and 2b are formed (FIG. 4E). Thereafter, the patterns 5a and 5b are removed, and then the interdigital current collectors 2a and 2b are exposed on the surface of the substrate 4 as shown in FIG. 4F.

### (Resist Application Step)

Next, a resist application step will be described. The resist application step is a step carried out after the above-mentioned current collector formation step and is shown in FIG. 4G.

In this step, a resist composition is applied to the surface of the substrate 4 including the parts of the current collectors 2a and 2b formed in the above-mentioned current collector formation step to form a resist layer 6.

Well-known methods can be used to form the resist layer 6 by applying the resist composition to the surface of the substrate 4, without particular limitation thereto. In the resist layer 6, the guide holes 7a and 7b are formed in order to form the positive-electrode active material layer 3a and the negative-electrode active material layer 3b, as described below. The guide holes 7a and 7b become a casting mold when forming the positive-electrode active material layer 3a and the negative-electrode active material layer 3b and thus are required to have a sufficient depth for forming the positive-electrode active material layer 3a and the negative-electrode active material layer 3b. The thickness of the resist layer 6 becomes the future depth of the guide holes 7a and 7b and thus is appropriately determined in consideration of the necessary depth of the guide holes 7a and 7b. The thickness of the resist layer 6 may be, for example, 10 to 100 μm, but is not particularly limited thereto.

As the resist composition used for forming the resist layer 6, any of (1) to (4) is used: (1) a cationic polymerization resist composition including a compound having an epoxy group and a cationic polymerization initiator, (2) a novolac resist composition including novolac resin and a photosensitizing agent, (3) a chemical amplification resist composition including resin, which has an acid dissociation leaving group and has alkali-solubility increased by the effect of acids generated from a photoacid generator by exposure of the leaving group, and a photoacid generator, or (4) a radical polymerization resist composition including a monomer and/or resin having an ethylenic unsaturated bond, as well as a radical polymerization initiator, wherein when the monomer having an ethylenic unsaturated bond is included, the number of ethylenic unsaturated bonds included in one molecule of the monomer is three or less. Hereinafter, for each resist composition, well-known compositions can be used.

### (Guide Hole Formation Step)

Next, a guide hole formation step will be described. The guide hole formation step is a step carried out after the above-mentioned resist application step, and is shown in FIG. 4H. It should be noted that in FIG. 4H, for easy understanding of the drawing, a current collector 2a located in the bottom part of the guide hole 7a is omitted.

In this embodiment, in this step, the guide holes 7a and 7b having the same shape in a plan view as those of the interdigital current collectors 2a and 2b are formed on the resist layer 6 formed in the above-mentioned resist application step. Guide holes 7a and 7b are formed as through-holes penetrating the resist layer 6 to the surfaces of the current collectors 2a and 2b. The guide holes 7a and 7b are used as a casting mold to deposit a positive electrode or a negative electrode active material in the active material layer formation step described later.

In this embodiment, in this step, firstly, the resist layer 6, which has been formed in the above-mentioned resist application step, is selectively exposed and developed through a mask having the same shape in a plan view as the shapes of the current collectors 2a and 2b. Consequently, when the resist layer 6 is formed of negative-type resist, a part not to be the future guide holes 7a and 7b is hardened and becomes insoluble to a developer, and a part to be the future guide holes 7a and 7b retains its solubility to the developer. Furthermore, when the resist layer 6 is formed of positive-type resist, the part to be the future guide holes 7a and 7b is soluble to a developer, and a part not to be the future guide holes 7a and 7b retains its insolubility to the developer.

The selectively exposed resist layer 6 is developed. The development can be carried out by well-known methods using well-known developers. Examples of such a developer include alkaline aqueous solutions. Furthermore, examples of the development processes include an immersion process, and a spraying process, and the like.

The guide holes 7a and 7b having the same shape in a plan view as those of the interdigital current collectors 2a and 2b and penetrating up to the surface of the current collectors 2a and 2b are formed in the developed resist layer 6. As necessary, after-curing by irradiation with an active energy beam such as UV rays or post-baking as additional heat treatment is applied to the resist layer 6 where the guide holes 7a and 7b have been formed. Solvent resistance and plating solution resistance of the resist layer 6 necessary in the active material layer formation step, as described later, are further improved by performing the after-curing or post-baking.

### (Active Material Layer Formation Step)

Next, an active material layer formation step will be described. The active material layer formation step is a step carried out after the above-mentioned guide hole formation step, and is shown in FIG. 4I.

In this step, the positive-electrode active material layer 3a is formed on the surface of the current collector 2a and the negative-electrode active material layer 3b is formed on the surface of the current collector 2b using the guide holes 7a and 7b, which have been formed in the above-mentioned guide hole formation step, as a casting mold, respectively. Thus, the electrodes 1a and 1b are completed.

Methods for forming the active material layers 3a and 3b on the surfaces of the current collectors 2a and 2b using the guide holes 7a and 7b a as a casting mold include electrophoresis or a plating process. These processes are described hereinafter.

Electrophoresis is a method including: immersing the substrate 4 provided with the guide holes 7a and 7b in a polar solvent in which positive or negative electrode active material particles are dispersed, and applying a voltage to either the current collector 2a or 2b, thereby selectively depositing the positive or negative electrode active material particles dispersed in the solvent on the surface of the current collector to which the voltage has been applied. Thereby, it is possible to deposit the active material layer 3a or 3b on either the current collector 2a or 2b using the guide hole 7a or 7b as a casting mold.

Examples of the active materials to be dispersed in the solvent include particles of positive-electrode active materials such as LiCoO₂, LiFePO₄, and LiMn₂O₄ and particles of negative-electrode active materials such as graphite, Li₄Ti₅O₁₂, Sn alloys, and Si-based compounds, having a particle diameter of 100 to 10000 nm, and preferably 100 to 1000 nm. Furthermore, an amount of the active material to be dispersed in the solvent is, for example, 1 to 50 g/L, and the solvent to be used is, for example, acetonitrile, N-methylpyrrolidone, acetone, ethanol, or water. Furthermore, a conductive aid and a binder, for example carbon black, polyvinylidene fluoride, and iodine, may be added to the solvent. The amount of the conductive aid and the binder in the solvent is, for example, 0.1 to 1 g/L, respectively.

When electrophoresis is carried out, a substrate of nickel or gold or the like is used as a counter electrode in a position about 1 cm above the current collector 2a or 2b to carry out the electrophoresis. At that time, a voltage is, for example, 1 to 1000 V. The electric field density is, for example, 1 to 1000 V/cm applied between the current collectors 2a and 2b, or between the current collector 2a or 2b and the counter electrodes to the current collector 2a or 2b.

The plating process is a method for forming the active material layer 3a or 3b on the surface of the current collector 2a or 2b using a water-soluble plating solution. Examples of such a plating solution include 0.01 to 0.3 M aqueous solution of SnCl₂.2H₂O, 0.01 to 0.3 M aqueous solution of a mixture of SnCl₂.2H₂O and NiCl₂.6H₂O, 0.01 to 0.3 M aqueous solution of a mixture of SnCl₂.2H₂O and SbCl₃, 0.01 to 0.3 M aqueous solution of a mixture of SnCl₂.2H₂O and CoCl₂, and 0.01 to 0.3M aqueous solution of a mixture of SnCl₂.2H₂O and CuSO₄. Furthermore, to the plating solution, glycine, K₄P₂O₇, NH₄OH aqueous solution, and the like may be added as additives at a concentration of, for example, 0.01 to 0.5 M.

Although not particularly limited, after the active material layer 3a or 3b is selectively formed on either the current collector 2a or 2b by the above-mentioned electrophoresis, the active material layer 3b or 3a may be selectively formed on the other of the current collector 2b or 2a on which the active material layer 3a or 3b is not formed by the above-mentioned plating process. Thus, the positive-electrode active material layer 3a is selectively formed on the surface of the current collector 2a, and the negative-electrode active material layer 3b is selectively formed on the surface of the current collector 2b, respectively.

Furthermore, in the formation of the active material layer 3a or 3b on the surface of the current collector 2a or 2b, in addition to the electrophoresis or the plating process mentioned above, an injection process can be carried out as necessary, wherein the solution, in which the positive electrode active material particles or the negative electrode active material particles are dispersed in the above-mentioned solvent, is injected into the guide hole 7a or 7b using a capillary.

As mentioned above, the active material layers 3a and 3b are formed by the electrophoresis or the plating process using the guide holes 7a and 7b formed on the resist layer 6 as a casting mold. Consequently, it is preferable that the resist layer 6 in the active material layer formation step has resistance to a solvent used in electrophoresis and a plating solution used in the plating process. Based on this point, among the resist compositions exemplified in the above (1) to (4), from the viewpoint of imparting resistance to the plating solution, (1) a cationic polymerization resist composition, (2) a novolac resist composition, or (3) a chemical amplification resist composition is preferable. Among the resist compositions of (1) to (3), from the viewpoint of imparting resistance to the solution to be used in the above-mentioned electrophoresis, (1) the cationic polymerization resist composition is more preferable.

After the active material layers 3a and 3b are formed on the surfaces of the current collectors 2a and 2b, respectively, the resist layer 6 provided with the guide holes 7a and 7b is removed. Thus, the electrodes 1a and 1b shown in FIG. 2 are formed. Methods for removing the resist layer 6 include an ashing process of decomposing the resist layer 6 by heating at a high temperature, and an etching process.

It should be noted that procedures in the above-mentioned resist application step, guide hole formation step, and active material layer formation step can also be executed by a below-mentioned first or second pattern formation method. That is to say, the interdigital electrodes 1a and 1b can be produced by, for example, forming the current collectors 2a and 2b in the current collector formation step, and forming the positive and negative electrodes on the current collectors 2a and 2b by using the first or second pattern formation method mentioned below.

### First Pattern Formation Method

A first pattern formation method is a pattern formation method in which n patterns (n: an integer of at least 2, and preferably 2) of identical or different pattern materials are formed on a support, and the method includes: forming a first resist layer by applying a positive-type resist composition to a surface of the support, the following steps of (1) to (3) are repeated for a kth pattern material and a kth resist layer in an order from k=1 to k=(n−1) (k: an integer of 1 to (n−1)): (1) forming a guide hole penetrating through the first to the kth resist layers by exposure and development; (2) filling the above-mentioned guide hole with a kth pattern material by a screen printing process; and (3) forming a (k+1)th resist layer by applying a positive-type resist composition to the kth resist layer and the kth pattern material which has been used to fill the guide holes, thus forming a guide hole penetrating the first to the nth resist layers by exposure and development, filling the guide hole with a nth pattern material by a screen printing process, and removing the first to the nth resist layers. According to the first pattern formation method, a plurality of patterns of identical or different pattern materials can be formed on the support for a short time.

Hereinafter, the first pattern formation method is described in detail with reference to the drawings. FIGS. 5A to 5H are longitudinal sectional views showing the first pattern formation method. With reference to FIGS. 5A to 5H, a pattern formation method in accordance with an embodiment of the present invention is described. It should be noted that the case of n=2 is described in FIGS. 5A to 5H.

Initially, in the step shown in FIG. 5B, the first resist layer 12 is formed by applying a positive-type resist composition to the surface of the support 11 shown in FIG. 5A.

Well-known methods can be used for the process to form the first resist layer 12 by applying the positive-type resist composition to the surface of the support 11, without particular limitation thereto. In the first resist layer 12, guide holes 13a and 13b are formed in order to form the pattern material layers 14a and 14b, as will be described later. The guide holes 13a and 13b become a casting mold when forming the pattern material layers 14a and 14b and thus are required to have a sufficient depth for forming the pattern material layers 14a and 14b. The thickness of the first resist layer 12 becomes the future depth of the guide holes 13a and 13b and thus is appropriately determined in consideration of the necessary depth of the guide holes 13a and 13b. The thickness of the first resist layer 12 may be, for example, 10 to 100 μm, but is not particularly limited thereto.

The positive-type resist composition used for forming the first resist layer 12 may be well-known compositions without particular limitation thereto, and may be non-chemical amplification type or chemical amplification type compositions. Examples of the non-chemical amplification type positive-type resist composition include those containing at least a quinone diazide group-containing compound (A) and an alkali-soluble resin (B). On the other hand, examples of the chemical amplification-type positive-type resist composition may include those containing at least a photoacid generator and a resin which has an acid-dissociating elimination group and increases alkali solubility when the elimination group is eliminated by action of an acid generated from the photoacid generator through exposure.

Next, the step shown in FIG. 5C is described.

In this step, initially, the first resist layer 12 is selectively exposed through a desired mask. Consequently, the part to be the future guide hole 13a becomes soluble to a developer, and the part not to be the future guide hole 13a retains its insolubility to the developer.

The selectively exposed first resist layer 12 is developed. The development can be carried out by well-known processes using well-known developers. The developer may be, for example, an alkaline aqueous solution. Furthermore, the development processes may be, for example, an immersion process, a spray process, and the like.

The guide hole 13a penetrating up to the surface of the support 11 is formed in the developed first resist layer 12. The guide hole 13a is used as a casting mold in order to deposit a pattern material in the step shown in FIG. 5D (described later). As necessary, after-curing by irradiation with an active energy beam such as UV rays or post-baking as additional heat treatment is applied to the first resist layer 12 where the guide hole 13a has been formed. Solvent resistance and plating solution resistance of the first resist layer 12 necessary at the step of filling the pattern material, as described later, are further improved by applying the after-curing or post-baking.

Next, the step shown in FIG. 5D is described.

In this step, the guide hole 13a formed in the step shown in FIG. 5C is filled with a first pattern material by a screen printing process. That is, the first pattern material layer 14a is formed on the surface of the support 11 using the guide hole 13a as a casting mold.

The screen printing process can be carried out using, for example, a commercially available screen printer while appropriately adjusting squeegee pressure; squeegee speed; and material, hardness, grinding angle, etc. of the squeegee used.

Next, the step shown in FIG. 5E is described.

In this step, a positive-type resist composition is applied to the first resist layer 12 and the guide hole 13a is filled with the first pattern material (that is, the first pattern material layer 14a) so as to form a second resist layer 15. The second resist layer 15 functions as a protective layer of the first pattern material layer 14a. That is to say, if the guide hole 13b is formed without forming the second resist layer 15 as described later, the first pattern material layer 14a is brought into contact with the developer and flows out in the process. As described above, formation of the second resist layer 15 can prevent the first pattern material layer 14a from being brought into contact with the developer and flowing out.

The type and coating process of the positive-type resist composition are similar to those described above as to the step shown in FIG. 5B. The positive-type resist composition used in the step shown in FIG. 5E may be the same as the positive-type resist composition used in the step shown in FIG. 5B, but is preferably different therefrom in terms of composition component or type.

The thickness of the second resist layer 15 is not particularly limited as long as its function as the protective layer for the first pattern material layer 14a is assured, and it is appropriately determined in consideration of the depth required for the guide hole 13b formed in the step shown in FIG. 5F mentioned later and it may be, for example, 1 to 20 μm.

Next, the step shown in FIG. 5F is described.

In this step, initially, the first resist layer 12 and the second resist layer 15 are selectively exposed through a desired mask. Consequently, the part to be the future guide hole 13b becomes soluble to a developer, and the part not to be the future guide hole 13b retains its insolubility to the developer.

The selectively exposed first resist layer 12 and second resist layer 15 are developed. The developer and the developing process are similar to those described in terms of the step shown in FIG. 5C.

The guide hole 13b penetrating up to the surface of the support 11 is formed in the developed first resist layer 12 and second resist layer 15. The guide hole 13b is used as a casting mold in order to deposit a pattern material in the step shown in FIG. 5G (described later). As necessary, after-curing by irradiation with an active energy beam such as UV rays or post-baking as additional heat treatment is applied to the first resist layer 12 and the second resist layer 15 where the guide hole 13b has been formed. Solvent resistance and plating solution resistance of the first resist layer 12 and the second resist layer 15 necessary at the step of filling the pattern material, as described later, are further improved by applying the after-curing or post-baking.

Next, the step shown in FIG. 5G is described.

In this step, the guide hole 13b formed in the step shown in FIG. 5F is filled with a second pattern material by a screen printing process. That is, the second pattern material layer 14b is formed on the surface of the support 11 using the guide hole 13b as a casting mold.

The conditions of the screen printing process are similar to those described in terms of the step shown in FIG. 5D.

Next, the step shown in FIG. 5H is described.

In this step, the first resist layer 12 and the second resist layer 15 are removed. Specifically, for example, a method of stripping these resist layers using a stripping liquid is employed. In this case, the stripping process is not particularly limited, and immersion processes, spray processes, shower processes, puddle processes, or the like may be used. Additionally, examples of the stripping liquid include 3 to 15 mass % aqueous solution of sodium hydroxide, aqueous solution of potassium hydroxide, organic amines, tetramethyl ammonium hydroxide, triethanolamine, N-methylpyrrolidone, dimethyl sulfoxide, acetone, and the like. The stripping treatment time may be, for example, about 1 to 120 minutes without particular limitation thereto. It should be noted that the stripping liquid may be warmed to about 25 to 60° C.

As mentioned above, two patterns composed of the first and second pattern materials can be formed on the support.

It should be noted that in FIGS. 5A to 5H, the case of n=2 is described. In the case where n is 3 or more, steps shown in FIGS. 5C to 5E are repeated a necessary amount of times, and n patterns composed of identical or different pattern materials can be formed on the support.

The positive electrode and the negative electrode can be formed on the current collectors 12a and 12b by carrying out patterning according to FIGS. 5A to 5H, for example, using the current collectors 12a and 12b in FIG. 2 as the support 11 in FIGS. 5A to 5H, using the positive-electrode active material layer 13a in FIG. 2 as the first pattern material layer 14a in FIGS. 5D to 5H, and using the negative-electrode active material layer 13b in FIG. 2 as the second pattern material layer 14b in FIGS. 5G to 5H.

### Second Pattern Formation Method

A second pattern formation method is a pattern formation method in which n patterns (n: an integer of at least 2, and preferably 2) of identical or different pattern materials are formed on a support, and the method includes: forming a first resist layer by applying a resist composition to a surface of the support, the following steps of (1) to (4) are repeated for a kth pattern material and a kth resist layer in order from k=1 to k=(n−1) (k: an integer of 1 to (n−1)): (1) forming a guide hole penetrating the kth resist layer by exposure and development, (2) filling the above-mentioned guide hole with a kth pattern material by a screen printing process, (3) removing the kth resist layer, and (4) forming a (k+1)th resist layer by applying a resist composition to the support and the first to the kth pattern materials, thus forming a guide hole penetrating the nth resist layer by exposure and development, filling the guide hole with the nth pattern material by a screen printing process, and removing the nth resist layer. According to the second pattern formation method, similar to the first pattern formation method, a plurality of patterns of identical or different pattern materials can be formed on the support for a short time.

Hereinafter, with reference to the drawings, the second pattern formation method will be described in detail.

FIGS. 6A to 6I are longitudinal sectional views showing a second pattern formation method. With reference to FIGS. 6A to 6I, a pattern formation method in accordance with an embodiment of the present invention is described. It should be noted that in FIGS. 6A to 6I, a case of n=2 is described.

Initially, in the step shown in FIG. 6B, the first resist layer 12 is formed by applying a resist composition to the surface of the support 11 shown in FIG. 6A.

Well-known methods can be used to form the first resist layer 12 by applying the resist composition to the surface of the support 11, without particular limitation thereto. In the first resist layer 12, the guide hole 13a is formed in order to form the pattern material layer 14a, as described later. The guide hole 13a becomes a casting mold when forming the pattern material layer 14a and thus is required to have a sufficient depth for forming the pattern material layer 14a. The thickness of the first resist layer 12 becomes the future depth of the guide hole 13a and thus is appropriately determined in consideration of the necessary depth of the guide hole 13a. The thickness of the first resist layer 12 is, for example, 10 to 100 μm, but is not particularly limited thereto.

The resist composition used for forming the first resist layer 12 may be a well-known composition without particular limitation thereto, and may be positive-type or negative-type. Furthermore, the positive-type resist composition may be a non-chemical amplification type or chemical amplification type. Examples of the non-chemical amplification type positive-type resist composition include those containing at least a quinone diazide group-containing compound and an alkali-soluble resin. On the other hand, examples of the chemical amplification-type positive-type resist composition may include those containing at least a photoacid generator and a resin which has an acid-dissociating elimination group and increases alkali solubility when the elimination group is eliminated by action of an acid generated from the photoacid generator through exposure. Furthermore, examples of the negative-type resist composition may include a polymerizable negative-type resist composition containing a least an alkali-soluble resin, a photopolymerizable monomer, and a photopolymerization initiator; a chemical amplification-type negative-type resist composition containing at least an alkali-soluble resin, a cross-linking agent, and an acid generator; and a chemical amplification-type negative-type resist composition for solvent-development processes containing at least a photoacid generator and a resin which has an acid-dissociating elimination group and increases polarity when the elimination group is eliminated by action of an acid generated from the photoacid generator through exposure. Among them, the chemical amplification-type resist composition is preferable and the positive-type resist composition is more preferable because the first resist layer 12 tends to be removed more easily in the step shown in FIG. 6E (described later).

Next, the step shown in FIG. 6C is described.

In this step, initially, the first resist layer 12 is selectively exposed through a desired mask. Consequently, when the first resist layer 12 is formed using a positive-type resist composition, the part to be the future guide hole 13a becomes soluble to a developer, and the part not to be the future guide hole 13a retains its insolubility to the developer. On the other hand, when the first resist layer 12 is formed using a negative-type resist composition, the part not to be the future guide hole 13a becomes insoluble to a developer, and the part to be the future guide hole 13a retains its solubility to the developer. As necessary, heating (PEB) is carried out after the selective exposure.

The selectively exposed first resist layer 12 is developed. The development can be carried out by well-known processes using well-known developers. The developer may be, for example, an alkaline aqueous solution, and, in cases of solvent development processes, ester solvents such as butyl acetate and ketone solvents such as methyl amyl ketone. Additionally, the developing process may be, for example, immersion processes, spray processes, puddle processes, dynamic dispense processes, and the like.

The guide hole 13a penetrating up to the surface of the support 11 is formed in the developed first resist layer 12. The guide hole 13a is used as a casting mold in order to deposit a pattern material in the step shown in FIG. 6D (described later). As necessary, after-curing by irradiation with an active energy beam such as UV rays or post-baking as additional heat treatment is applied to the first resist layer 12 where the guide hole 13a has been formed. Solvent resistance and plating solution resistance of the first resist layer 12 necessary at the step of filling the pattern material, as described later, are further improved by applying the after-curing or post-baking.

Next, the step shown in FIG. 6D is described.

In this step, the guide hole 13a formed in the step shown in FIG. 6C is filled with a first pattern material by a screen printing process. That is, the first pattern material layer 14a is formed on the surface of the support 11 using the guide hole 13a as a casting mold.

The screen printing process can be carried out using, for example, a commercially available screen printer while appropriately adjusting squeegee pressure; squeegee speed; and material, hardness, grinding angle, or the like of the squeegee used.

Next, the step shown in FIG. 6E is described.

In this step, the first resist layer 12 is removed.

Specifically, for example, a method for stripping the first resist layer 12 using a stripping liquid is employed. In this case, the stripping process is not particularly limited, and immersion processes, spray processes, shower processes, puddle processes, or the like may be used as the stripping process. Additionally, the stripping liquid may be appropriately selected depending on the components of the resist composition used in the resist layer and may be, for example, 3 to 15 mass % aqueous solution of sodium hydroxide, aqueous solution of potassium hydroxide, organic amines, aqueous solution of tetramethyl ammonium hydroxide, triethanolamine, N-methylpyrrolidone, dimethyl sulfoxide, acetone, and other resist solvents such as propylene glycol monomethyl ether acetate. The stripping treatment time may be, for example, about 1 to 120 minutes, but is not particularly limited thereto. It should be noted that the stripping liquid may be warmed to about 25 to 60° C.

In this step, one pattern made of the first pattern material is formed on the support.

Next, the step shown in FIG. 6F is described.

In this step, the resist composition is applied to the support 11 and the first pattern material layer 14a to thereby form the second resist layer 15. In the second resist layer 15, the guide hole 13b is formed for forming the pattern material layer 14b, as described later. The guide hole 13b becomes a casting mold when forming the pattern material layer 14b and thus is required to have a sufficient depth for forming the pattern material layer 14b. Furthermore, the second resist layer 15 is formed on the first pattern material layer 14a and thus also functions as a protective layer of the first pattern material layer 14a. That is, if the guide hole 13b is formed without forming the second resist layer 15 on the first pattern material layer 14a, as described later, the first pattern material layer 14a is brought into contact with the developer and flows out in the process. As described above, formation of the second resist layer 15 on the first pattern material layer 14a can prevent the first pattern material layer 14a from being brought into contact with the developer and flowing out.

The type and coating process of the resist composition are similar to those described above as to the step shown in FIG. 6B. The resist composition used in the step shown in FIG. 6F may be the same as the resist composition used in the step shown in FIG. 6B or different therefrom in terms of compositional component or type.

The thickness of the second resist layer 15 is not particularly limited as long as its function as the protective layer for the first pattern material layer 14a is assured, and it is appropriately determined in consideration of the depth required for the guide hole 13b formed in the step shown in FIG. 6G mentioned later and it may be, for example, 1 to 20 μm.

Next, the step shown in FIG. 6G is described.

In this step, initially, the second resist layer 15 is selectively exposed through a desired mask. Consequently, when the second resist layer 15 is formed using a positive-type resist composition, the part to be the future guide hole 13b becomes soluble to a developer and the part not to be the future guide hole 13b retains its insolubility to the developer. On the other hand, when the second resist layer 15 is formed using a negative-type resist composition, the part not to be the future guide hole 13b becomes insoluble to a developer, and the part to be the future guide hole 13b retains its solubility to the developer. As necessary, heating (PEB) is carried out after the selective exposure.

The selectively exposed second resist layer 15 is developed. The developer and the development process are the same as those described for the step shown in FIG. 6C. The guide hole 13b penetrating up to the surface of the support 11 is formed in the developed second resist layer 15. The guide hole 13b is used as a casting mold in order to deposit a pattern material in the step shown in FIG. 6H (described later). As necessary, after-curing by irradiation with an active energy beam such as UV rays or post-baking as additional heat treatment is applied to the second resist layer 15 where the guide hole 13b has been formed. Solvent resistance and plating solution resistance of the second resist layer 15 necessary at the step of filling the pattern material, as described later, are further improved by applying the after-curing or post-baking.

Next, the step shown in FIG. 6H is described.

In this step, the guide hole 13b formed in the step shown in FIG. 6G is filled with a second pattern material by a screen printing process. That is, the second pattern material layer 14b is formed on the surface of the support 11 using the guide hole 13b as a casting mold.

The conditions of the screen printing process are similar to those described in terms of the step shown in FIG. 6D.

Next, the step shown in FIG. 6I is described.

In this step, the second resist layer 15 is removed. Specifically, for example, a method for stripping the second resist layer 15 using a stripping liquid is employed. The stripping process, stripping liquid, and stripping treatment time are similar to those described in terms of the step shown in FIG. 6E.

As described above, two patterns of the first and second pattern materials can be formed on the support.

It should be noted that in FIGS. 6A to 6I, the case of n=2 is described. In the case of n=3 or more, steps shown in FIGS. 6C to 6F are repeated a necessary amount of times, and n patterns composed of identical or different pattern materials can be formed on the support.

The positive electrode and the negative electrode can be formed on the current collectors 12a and 12b by carrying out patterning according to FIGS. 6A to 6I, for example, using the current collectors 12a and 12b in FIG. 2 as the support 11 in FIGS. 6A to 6I, using the positive-electrode active material layer 13a in FIG. 2 as the first pattern material layer 14a in FIGS. 6D to 6I, and using the negative-electrode active material layer 13b in FIG. 2 as the second pattern material layer 14b in FIGS. 6H and 6I.

### [Cover Member Bonding Step]

Cover member bonding steps are sequentially shown in FIGS. 3B and 3C.

In this step, the cover member 9 is bound to the surface of the substrate 4. As a result, an airtight chamber containing the interdigital electrodes 1a and 1b is defined by the substrate 4 and the cover member 9. Examples of the method for bonding the cover member 9 to the surface of the substrate 4 include methods used in the field of semiconductors, for example, a method using an adhesive agent such as an epoxy adhesive agent, soldering, anode junction, and the like.

### [Electrolyte Filling Step]

An electrolyte filling step is a step shown in FIG. 3C.

In this step, the airtight chamber defined in the cover member bonding step was filled with the electrolyte 8 involved in a battery reaction between the interdigital electrodes 1a and 1b. Filling of the electrolyte 8 is carried out through two liquid injection holes 10 formed in the lateral surface of the cover member 9. A filling method is not particularly limited, and may include an infusion under reduced pressure, infusion using a syringe, and the like, but infusion under reduced pressure is preferable from the viewpoint that the degree of charging efficiency is high and filling inconsistency does not easily occur. The infusion under reduced pressure can be carried out by immersing a structure composed of the substrate 4 and the cover member 9 into the electrolyte 8 and reducing pressure.

It should be noted that in order to prevent leakage of the electrolyte 8, moisture absorption of the electrolyte 8, or the like, after filling of the electrolyte 8, the liquid injection hole 10 is sealed with the adhesive agent 50 such as an epoxy adhesive agent.

A nonaqueous secondary battery 100A in accordance with another embodiment of the present invention is described. The nonaqueous secondary battery 100A is the same as the nonaqueous secondary battery 100 except that nonaqueous secondary battery 100A includes a cover member 9A, which does not have the liquid injection hole 10, instead of the cover member 9.

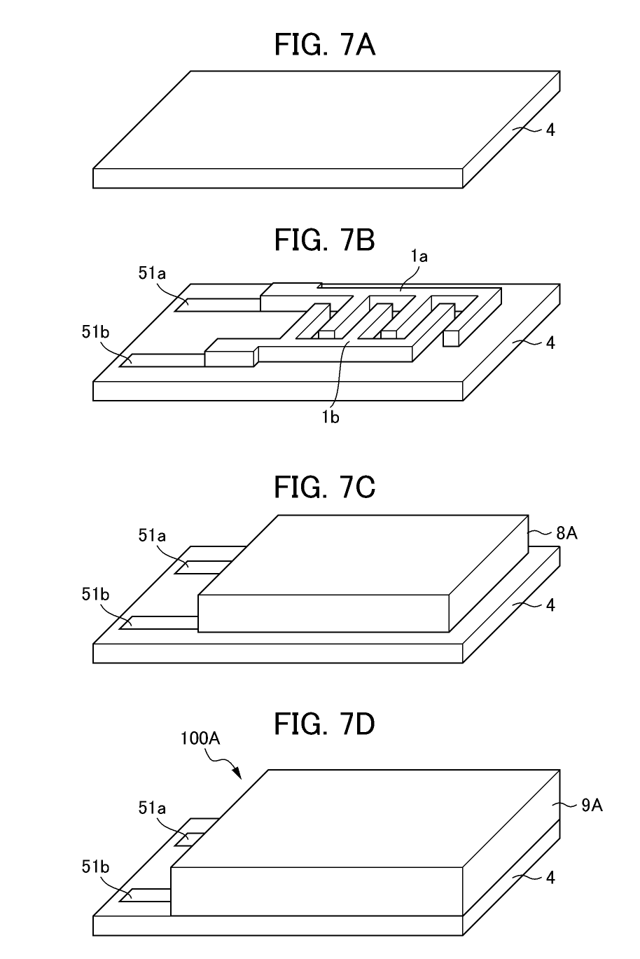

Hereinafter, a method for manufacturing the nonaqueous secondary battery 100A in accordance with another embodiment of the present invention is described. The manufacturing method of the nonaqueous secondary battery 100 in accordance with the present embodiment includes at least an electrode formation step, an electrolyte disposing step, and a cover member fixing step. While the manufacturing method of the nonaqueous secondary battery according to the present invention includes the electrode formation step and the filling step, the manufacturing method of the nonaqueous secondary battery 100 includes, as the filling step, the electrolyte disposing step and further includes the cover member fixing step. Hereinafter, each step is described with reference to FIGS. 7A to 7D.

### [Electrode Formation Step]

An electrode formation step includes steps which are sequentially shown in FIGS. 7A and 7B, and are similar to those described in terms of the steps sequentially shown in FIGS. FIGS. 3A and 3B, and therefore the description therefor is omitted herein.

### [Electrolyte Disposing Step]

An electrolyte disposing step is a step shown in FIG. 7C. In this step, the electrolyte 8A involved in a battery reaction between the interdigital electrode 1a and the interdigital electrode 1b is disposed at least between the facing end surfaces of the interdigital electrode 1a and the interdigital electrode 1b. The electrolyte 8A is the same as the electrolyte 8. The electrolyte 8A may be an electrolyte precursor which contains an excessive amount of organic solvent described above. A method of disposing the electrolyte 8A is not particularly limited, and examples of the method include a method of applying the electrolyte to at least the interdigital electrode 1a, the interdigital electrode 1b and the substrate 4 and a method of pouring the electrolyte in a concave portion which is arranged on the substrate 4 so as to surround the interdigital electrode 1a and the interdigital electrode 1b and which is formed with, for example, a frame member made of EPDM rubber and the substrate 4. After the application of the electrolyte 8A or the pouring of the electrolyte 8A in the concave portion, as necessary, heating processing, drying processing, vacuum-drying processing or the like may be performed. For example, when the electrolyte 8A obtained can stand by itself, the frame member may be removed after the arrangement of the electrolyte 8A.

### [Cover Member Fixing Step]

A cover member fixing step is a step shown in FIG. 7D.

In this step, the cover member 9A is fixed on the substrate 4. As a result, the airtight chamber containing the interdigital electrodes 1a and 1b is defined by the substrate 4 and the cover member 9A, and is filled with the electrolyte 8A. A method for fixing the cover member 9A on the substrate 4 is not particularly limited, and examples of the method include a method of attaching a coating film (for example, a PET film or a glass film) made of material exemplified in terms of the cover member 9 to the electrolyte 8A disposed in the electrolyte disposing step, directly or through an adhesive agent such as an epoxy adhesive agent, a method of coating the electrolyte 8A disposed in the electrolyte disposing step or the above-mentioned coating film attached to the electrolyte 8A with gas barrier material, and the like. Examples of the method of coating with gas barrier material include a method of forming a coating membrane made of gas barrier material by film-forming organic or inorganic gas barrier material on the electrolyte 8A disposed in the electrolyte disposing step or on the above-mentioned coating film attached to the electrolyte 8A by an application process, a vacuum film-formation process, or the like and a method of enclosing the electrolyte 8A disposed in the electrolyte disposing step and the substrate 4 with a coating film made of the gas barrier material. The electrolyte 8A or the coating membrane made of the gas barrier material formed on the above-mentioned coating film attached to the electrolyte 8A may be ones formed of a plurality of different gas barrier materials by, for example, a method of forming a coating membrane made of inorganic gas barrier material by film-forming inorganic gas barrier material on a coating membrane made of organic gas barrier material, a method of forming a coating membrane made of organic or inorganic gas barrier material by film-forming organic or inorganic gas barrier material on the above-mentioned coating film attached to the electrolyte 8A, and a method of forming a coating membrane made of organic gas barrier material by film-forming organic gas barrier material on a coating membrane made of inorganic gas barrier material, and the like. In the case of forming a coating membrane made of inorganic gas barrier material, for example: a film of metal such as aluminum may be formed by a coating process, a vacuum film formation process, or the like, on the electrolyte 8A, on the above-mentioned coating film attached to the electrolyte 8A, or on a coating membrane made of organic gas barrier material; a below-mentioned coating membrane made of inorganic compound coating material may be formed by a coating process, a vacuum film formation process, or the like; or a laminated cell may be used as a coating membrane to enclose the electrolyte 8A, the coating film adhered to the electrolyte 8A, the coating membrane made of organic gas barrier material and the substrate 4 altogether.

Examples of the organic gas barrier material include cycloolefin resin, polyethylene resin, polytetrafluoroethylene resin, polymethyl methacrylate (PMMA), and the like. As the organic gas barrier material, rubber materials such as styrene resin and butadiene resin may be used. In this case, it is preferable to use an inorganic gas barrier material and/or sealing material together with the organic gas barrier material. Examples of the inorganic gas barrier material include inorganic compound coating materials such as amorphous silicon, silicon nitride, silicon oxide, silicon oxynitride, ITO, aluminum nitride, and aluminum oxide; metal such as aluminum; and the like. Furthermore, examples of the application process of gas barrier material include spin coating, spray coating, and the like. When the gas barrier material includes the inorganic gas barrier material, a vacuum film formation method such as a sputtering process, a vapor deposition method, or a CVD method may be used. Furthermore, the coating membrane made of gas barrier material may be sealed with sealing material. Examples of the sealing material include epoxy resin such as cresol novolac epoxy resin, phenol novolac epoxy resin, biphenyl diepoxy resin, and naphthol novolac epoxy resin. The sealing material may include an additive such as a filler.

Since the method for manufacturing the nonaqueous secondary battery 100A in accordance with the other embodiment of the present invention does not require an injection operation for an electrolyte solution, a plurality of nonaqueous secondary batteries (unit cells) can be formed on the substrate at the same time. In the electrode formation step, a plurality of pairs of the positive electrode and the negative electrode having a combination of patterns of various circuits (series circuits or parallel circuits) or a combination of various sizes are formed on the substrate according to the desired unit cell, and the substrate is subjected to the electrolyte disposing step and the cover member fixing step, and thereby, the substrate provided with a plurality of nonaqueous secondary batteries (unit cells) can be obtained. The substrate can be then subjected to a dividing process according to the desired unit cells, and thereby a plurality of unit cells having various electrode patterns or sizes can be manufactured with high efficiency at the same time.

It should be noted that the dividing process may be carried out at any of the stages before the electrolyte disposing step or the cover member fixing step.

Furthermore, also in the embodiment in which infusing of an electrolyte solution is carried out, in the electrode formation step, depending upon the desired unit cells, a plurality of pairs of the positive electrode and the negative electrode having a combination of patterns of various circuits (series circuits or parallel circuits) or a combination of various sizes may be formed on the substrate. In this case, the dividing process can be carried out at any of the stages after the electrode formation step and before the electrolyte filling step.

### EXAMPLES

Hereinafter, the present invention is described more specifically with reference to examples; however, the present invention is not limited to the examples at all.

### Synthesis Example 1

Propylene glycol monomethyl ether acetate (PGMEA) as a solvent was added to 70 parts by mass of a cresol-type novolac resin (mass average molecular weight: 30000) resulting from an ordinary method of addition condensation between a mixture of m-cresol and p-cresol (m-cresol/p-cresol=6/4 (mass ratio)) and formaldehyde in the presence of an acid catalyst, 15 parts by mass of naphthoquinone-1,2-diazide-5-sulfonic acid diester of 1,4-bis(4-hydroxyphenyl isopropylidenyl)benzene as a photosensitizing agent, and 15 parts by mass of poly(methyl vinyl ether) (mass average molecular weight: 100000) as a plasticizer such that the solid content concentration is 40 mass % followed by mixing and dissolving, thereby obtaining a resist composition 1. The resist composition 1 is novolac type, non-chemical amplification type, and positive type.

### Synthesis Example 2

52.5 parts by mass of a cresol-type novolac resin (mass average molecular weight: 10000) resulting from an ordinary method of addition condensation between a mixture of m-cresol and p-cresol (m-cresol/p-cresol=6/4 (mass ratio)) and formaldehyde in the presence of an acid catalyst, 10 parts by mass of a polyhydroxystyrene resin VPS-2515 (manufactured by Nippon Soda Co.), 27.5 parts by mass of a resin expressed by Formula (1) below, 10 parts by mass of a resin expressed by Formula (2) below, 2 parts by mass of a compound expressed by Formula (3) below as an acid generator, 2 parts by mass of 1,5-dihydroxynaphthalene as a sensitizer, 0.01 parts by mass of triethylamine and 0.02 parts by mass of salicylic acid as additives, and 107 parts by mass of PGMEA and 6 parts by mass of gamma-butyrolactone as solvents were mixed and dissolved, thereby obtaining a resist composition 2. The resist composition 2 is chemical amplification type and positive type.

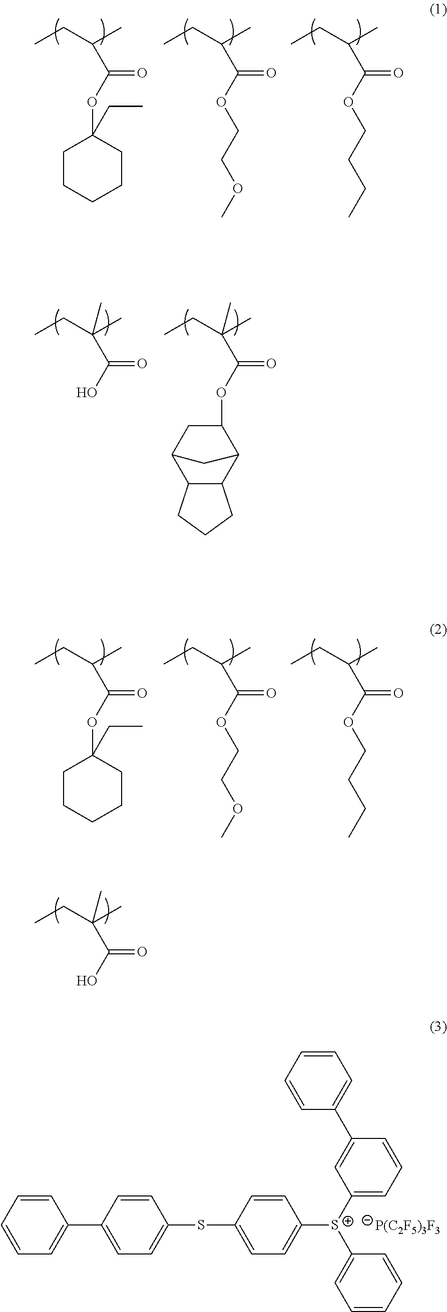

### Example 1

The interdigital electrodes 1a and 1b shown in FIG. 2 were produced using a screen printing process (the second pattern formation method described above). The entire size of interdigital electrodes, thickness of teeth, space between two adjacent teeth, length of teeth, number of teeth, and thickness of the active material layer were set as shown in Table 1.

TABLE 1

| | Entire size of | | Space | | | Thickness |
|---|---|---|---|---|---|---|
| | comb-shaped | Thickness | between | Length of | | of active |
| | electrode | of teeth | teeth | teeth | Number of | material layer |
| | (mm × mm) | (μm) | (μm) | (mm) | teeth | (μm) |
| Example 1 | 25 × 13 | 40 | 30 | 12.92 | 187 | 40 |

### (Formation of Current Collector)

Initially, an aluminum film (thickness: 400 nm) as a conductive layer was formed by a sputtering process on the surface of a silicon substrate having an oxide film on the upper layer of which a titanium thin film had been formed as an adhesion imparting layer (i.e. the surface of a titanium thin film). The positive-type resist composition 1 of Synthesis Example 1 was applied to the substrate by a spin coating process to thereby form a resist layer of 1.5 μm, followed by drying at 120° C. for 1 minute. Then, the resist layer was selectively exposed (ghi mixed rays, exposure amount: 100 mJ/cm²) using a mask with a pattern corresponding to the interdigital electrodes 1a and 1b shown in FIG. 2. Next, development was carried out with an alkaline developer of 2.38 mass % TMAH for 1 minute. After the development, the aluminum film and the titanium thin film were etched by a dipping process using an aluminum etching liquid (H₃PO₄:HNO₃:H₂O=4:1:1.6 (mass ratio)) to thereby form an aluminum pattern (pattern having a pattern of titanium thin film at the lower layer), thereby forming interdigital current collectors 12a and 12b.

### (Forming of Guide Hole (1))

The resist composition of Synthesis Example 1 was coated by a spin coating process on a surface of a silicon wafer on which the current collector had been formed, to thereby form a resist layer of 50 μm, followed by drying at 140° C. for 5 minutes. Then, using a positive mask having the same shape in a plan view as that of the above-formed interdigital current collector 12a, the resist layer at the position above the interdigital current collectors was exposed (ghi mixed rays, exposure amount: 60 mJ/cm²). Next, baking was carried out at 85° C. for 3 minutes as an activation step, followed by development with an alkaline developer. Consequently, a interdigital guide hole having the same shape in a plan view as that of the current collector 12a was formed on the surface of the silicon wafer. The current collector 12a was exposed at the base of the guide hole.

### (Formation of Active Material Layer (1))

34.02 g of LiFePO₄ particles, 5.04 g of acetylene black as a conductive aid, 2.10 g of carboxymethylcellulose as a dispersant, and 0.84 g of styrene-butadiene rubber (SBR) as a binder (mass ratio of 81:12:5:2) were mixed and 58 g of water was further added and mixed, thereby obtaining a dispersion liquid with a solid content of 42 mass %. The dispersion liquid was further mixed and dispersed by rotating at 2000 rpm for 10 minutes in a rotation-revolution type mixer (product name: Awatori Neritaro, manufactured by Thinky Co.) and the resulting mixture was used as a positive-electrode active material.

Screen printing was carried out on the silicon wafer where the guide hole had been formed and the guide hole was filled with the positive-electrode active material followed by drying at 100° C. for 5 minutes, thereby forming a positive-electrode active material layer. The screen printing was carried out at a squeegee pressure of 180 MPa and a squeegee speed of 15.0 mm/sec using a screen printer (model MT-320T, manufactured by Micro-tec Co.) equipped with a silicon squeegee polished to an angle of 45° and having a hardness of 60°.

### (Stripping of Resist Layer (1))

The resist layer was stripped off with acetone.

### (Forming of Guide Hole (2))

The resist composition 2 of Synthesis Example 2 was coated by a spin coating process on a surface of a silicon wafer on which the positive-electrode active material had been deposited to thereby form a resist layer of 60 μm, followed by drying at 140° C. for 1 minute.

Using a positive mask having the same shape in a plan view as that of the above-formed interdigital current collector 12b, the resist layer at the position above the interdigital current collectors was exposed (ghi mixed rays, exposure amount: 60 mJ/cm²). Next, baking was carried out at 85° C. for 3 minutes as an activation step, followed by development with an alkaline developer. Consequently, while protecting the positive-electrode active material with the resist layer functioning also as a protective layer, a interdigital guide hole having the same shape in a plan view as that of the current collector 12b was formed on the surface of the silicon wafer. The current collector 12b was exposed at the base of the guide hole.

### (Formation of Active Material Layer (2))

34.02 g of Li₄Ti₅O₁₂ particles, 5.04 g of acetylene black as a conductive aid, 2.10 g of carboxymethylcellulose as a dispersant, and 0.84 g of SBR as a binder (mass ratio of 87:6:5:2) were mixed and 58 g of water was further added and mixed, thereby obtaining a dispersion liquid with a solid content of 42 mass %. The dispersion liquid was further mixed and dispersed by rotating at 2000 rpm for 10 minutes in a rotation-revolution type mixer (product name: Awatori Neritaro, manufactured by Thinky Co.) and the resulting mixture was used as a negative-electrode active material.

Screen printing was carried out on the silicon wafer where the guide hole had been formed and the guide hole was filled with the negative-electrode active material followed by drying at 100° C. for 5 minutes, thereby forming a negative-electrode active material layer. The screen printing was carried out at a squeegee pressure of 180 MPa and a squeegee speed of 15.0 mm/sec using a screen printer (model MT-320T, manufactured by Micro-tec Co.) equipped with a silicon squeegee polished to an angle of 45° and having a hardness of 60°.

### (Stripping of Resist Layer (2))

Finally, the resist layer was stripped off with acetone, thereby obtaining interdigital electrodes 1a and 1b. The time required for filling the electrode active materials by the screen printing process was as very short as 15 minutes.

### <Rate Property and Cycle Property>

### Example 2

A dispersion liquid obtained by dispersing, in hexane, the particles of lithium lanthanum zirconium (hereinafter also referred to as a “LLZ”) which were ion conductive inorganic solid electrolyte particles was put into a ball mill together with a zirconium ball whose diameter was 5 mm, and pulverization processing was performed at 400 rpm for 3 hours. In this way, a LLZ fine powder whose average particle diameter was 0.73 μm was obtained.

On the other hand, while 1.0 mole of methyl tetraglyme (made by Kishida Chemical Co., Ltd., G4) was being agitated with a magnetic stirrer, 1.0 mole of lithium bis (fluorosulfonyl) imide (hereinafter also referred to as a “LiFSI”) was put thereinto, they were mixed uniformly and thus a liquid electrolyte component was obtained.

The LLZ fine powder and the liquid electrolyte component obtained as described above were mixed uniformly in a mortar, and an electrolyte containing 25 volume % of the LLZ fine powder was obtained.

The electrolyte was poured into a concave portion which was formed with a frame member made of EPDM rubber arranged on a silicon substrate so as to surround the interdigital electrode 1a and the interdigital electrode 1b obtained in example 1 and the silicon substrate, a glass plate was placed on the frame member and a region surrounded by the frame member, the silicon substrate and the glass plate was hermetically sealed. A vacuum grease was applied between the frame member and the glass plate, and thus the hermetical sealing was assured. The silicon substrate and the glass plate were fixed with a clip, and thus a lithium ion secondary battery was obtained.

The thickness of the lithium ion secondary battery obtained as described above was about 2.7 mm, and was much thinner than a conventional lithium ion secondary battery.

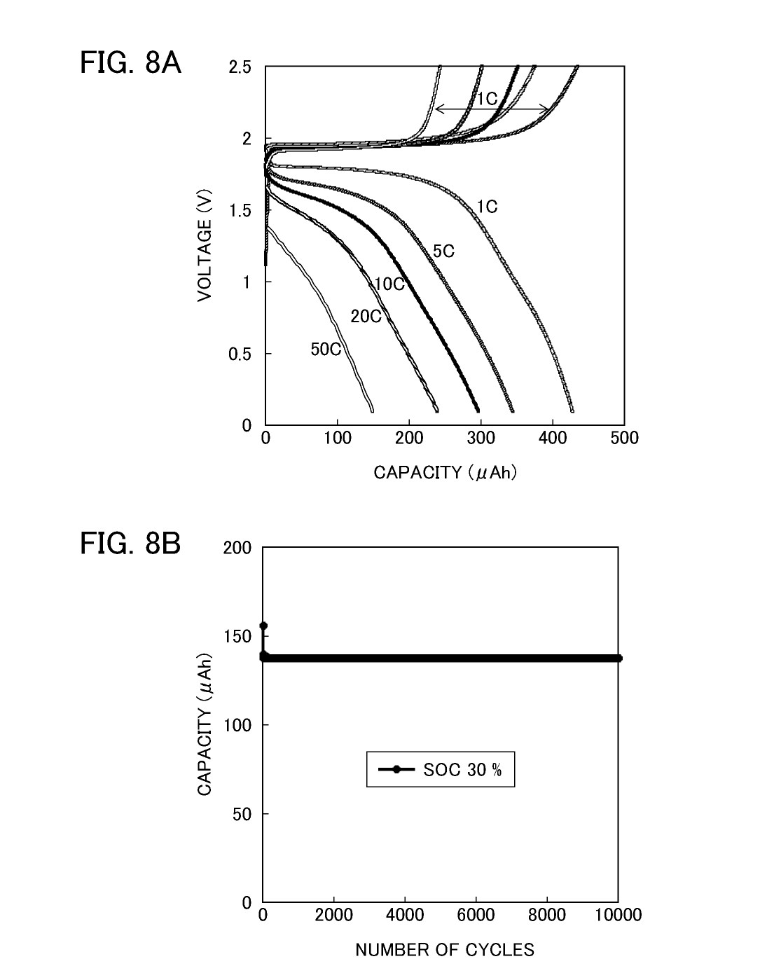

For the secondary battery, C rate was set at 1 C, 5 C, 10 C, 20 C or 50 C, and charging and discharging were performed. A charging and discharging curve is shown in FIG. 8A.

It is found from these results that the lithium ion secondary battery which is the nonaqueous secondary battery according to the present invention has a satisfactory rate property.

On the lithium ion secondary battery produced as described above, charging and discharging were performed as described above, (C rate: 50 C). The charging and discharging were repeatedly performed 100000 cycles, and a discharge capacity was measured in each cycle. The discharge capacity in each cycle is shown in FIG. 8B. SOC means a charging rate, and a SOC of 30% indicates a state in which when a full charging capacity is assumed to be 100%, 30% thereof is charged.

It is found from these results that in the lithium ion secondary battery which is the nonaqueous secondary battery according to the present invention, a capacity retention rate is stable even after 100000 cycles.

### Example 3

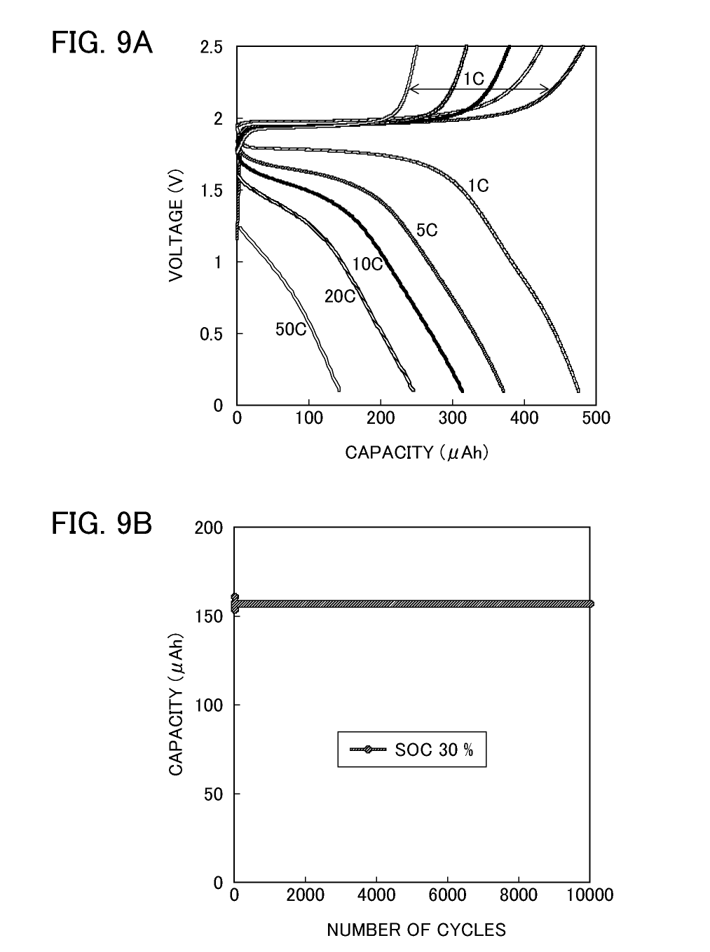

On the lithium ion secondary battery produced as in example 2 except that the content of the LLZ fine powder was changed from 25 volume % to 30 volume %, as in example 2, the rate property and the cycle property were checked. A charging and discharging curve is shown in FIG. 9A, and a discharge capacity in each cycle is shown in FIG. 9B.

It is also found from these results that in the lithium ion secondary battery which is the nonaqueous secondary battery according to the present invention, a satisfactory rate property is produced and a capacity retention rate is stable even after 100000 cycles.

### Example 4

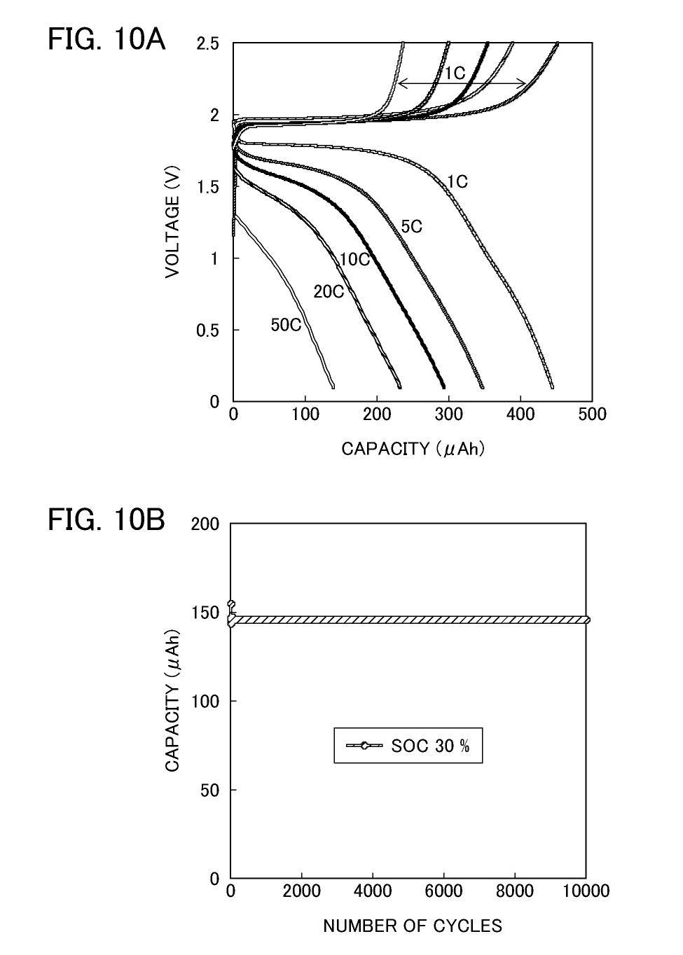

On the lithium ion secondary battery produced as in example 2 except that the content of the LLZ fine powder was changed from 25 volume % to 35 volume %, as in example 2, the rate property and the cycle property were checked. A charging and discharging curve is shown in FIG. 10A, and a discharge capacity in each cycle is shown in FIG. 10B.

It is also found from these results that in the lithium ion secondary battery which is the nonaqueous secondary battery according to the present invention, a satisfactory rate property is produced and a capacity retention rate is stable even after 100000 cycles.

### Comparative Example 1

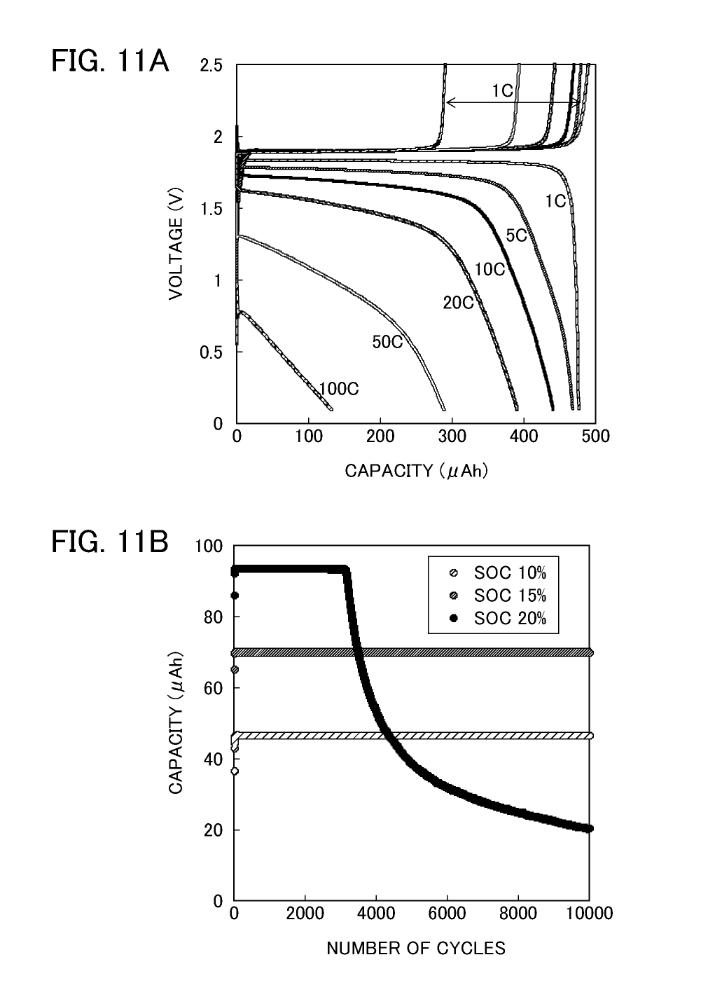

Except that instead of the electrolyte containing the LLZ fine powder and the liquid electrolyte component, an organic electrolyte liquid (1 M of LiClO₄ solution (where a solvent is an ethylene carbonate.ethyl methyl carbonate mixture having a volume ratio of 3:7)) was used, as in example 2, the rate property and the cycle property were checked on the lithium ion secondary battery produced. A charging and discharging curve is shown in FIG. 11A, and a discharge capacity in each cycle is shown in FIG. 11B.

It is found from these results that the conventional lithium ion secondary battery using the organic electrolyte liquid has a satisfactory rate property but a capacity retention rate is insufficient even after 100000 cycles though the conditions of SOC are lower than in examples.

### Comparative Example 2

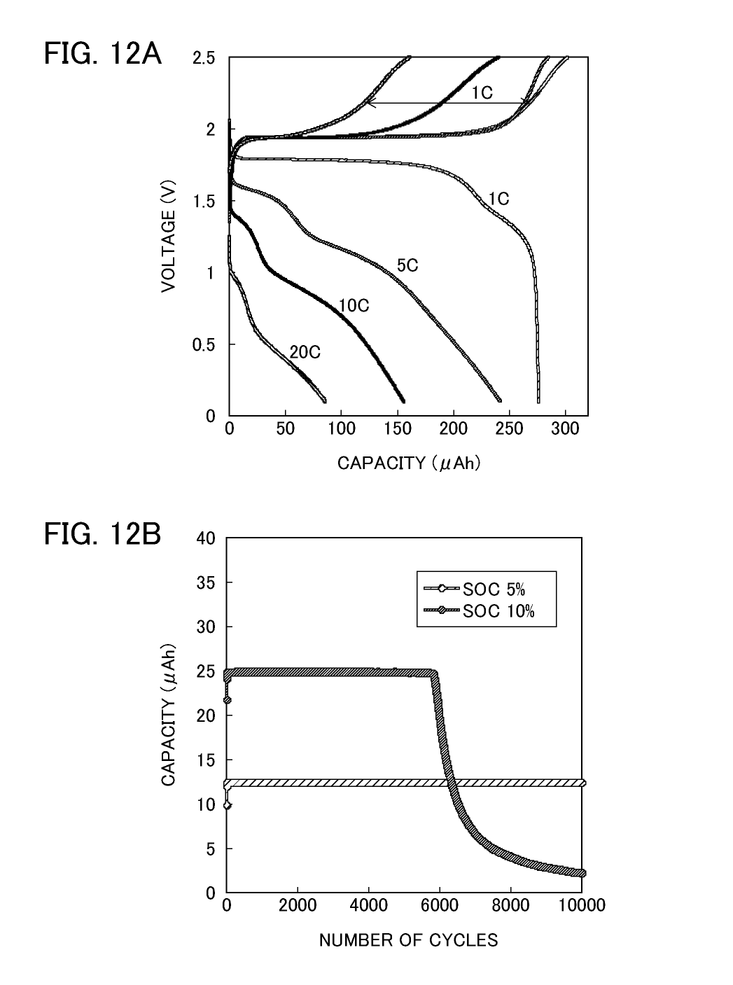

In example 2, instead of the electrolyte containing the LLZ fine powder and the liquid electrolyte component, a gel electrolyte precursor containing 70 mass % of an organic electrolyte liquid (1 M of LiClO₄ solution (where a solvent is an ethylene carbonate.propylene carbonate mixture having a volume ratio of 1:1)), 28 mass % of methyl methacrylate serving as a monomer, 1.5 mass % of ethylene glycol dimethacrylate serving as a cross-linking agent and 0.5 mass % of AIBN(azobisisobutyronitrile) serving as a polymerization initiator was poured into the concave portion, thermal processing was performed at 80° C. for 60 minutes to promote a polymerization reaction and thus a poly (methyl methacrylate) gel electrolyte was prepared. Except that instead of the electrolyte containing the LLZ fine powder and the liquid electrolyte component, the gel electrolyte was used, as in example 2, the rate property and the cycle property were checked on the lithium ion secondary battery produced as in example 2. However, C rate when the cycle property was checked was set at 20 C. A charging and discharging curve is shown in FIG. 12A, and a discharge capacity in each cycle is shown in FIG. 12B.

It is found from these results that the conventional lithium ion secondary battery using the gel electrolyte is lower in the rate property and the cycle property.

### Example 5

The LLZ fine powder obtained in example 2, the liquid electrolyte component obtained in example 2 and octanol were mixed uniformly in a mortar, and thus an electrolyte precursor containing 25 volume % of the LLZ fine powder was obtained. The mass ratio between the liquid electrolyte component and octanol was 72.5:27.5.

In example 2, instead of the electrolyte containing the LLZ fine powder and the liquid electrolyte component, the electrolyte precursor was poured into the concave portion, heat drying processing was performed at 60° C. for 24 hours and vacuum drying processing was performed at 60° C. for 10 minutes. Consequently, an electrolyte which contained 35 volume % of the LLZ fine powder and which stood by itself was obtained. It can be considered that the increase in the content of the LLZ fine powder was caused by the evaporation of octanol. The frame member was removed, the entire interdigital electrode and electrolyte was enclosed in a laminated cell, and thus a lithium ion secondary battery was obtained.

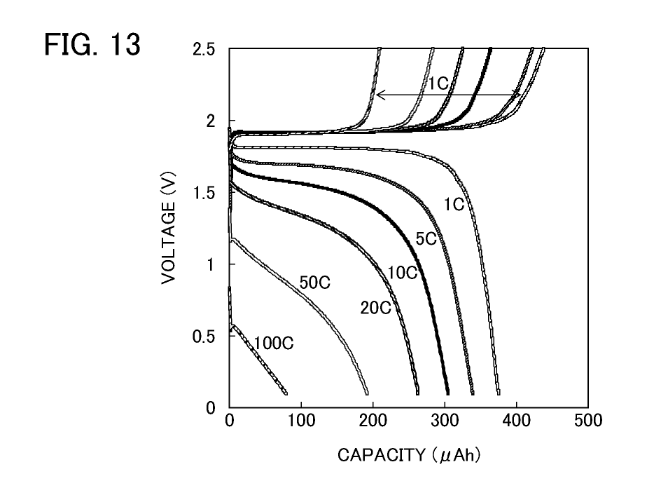

As in example 2, the rate property was checked on the lithium ion secondary battery. A charging and discharging curve is shown in FIG. 13.

It is also found from these results that in the lithium ion secondary battery produced as described above, a satisfactory rate property is produced.

### EXPLANATION OF REFERENCE NUMERALS

1a, 1b Interdigital electrode
2 Conductive layer
2a, 2b Current collector
3a, 3b Active material layer
4 Substrate
5 Current collector-formation resist layer
5a, 5b Resin pattern
6 Resist layer
7a, 7b Guide hole
8, 8A Electrolyte
9, 9A Cover member
10 Liquid injection hole
11 Support
12 First resist layer
13a, 13b Guide hole
14a, 14b Pattern material layer
15 Second resist layer
50 Adhesive agent
51a, 51b Terminal
100, 100A Nonaqueous secondary battery

What is claimed is:

1. A nonaqueous secondary battery comprising a positive electrode, a negative electrode, a substrate, and an electrolyte,
wherein respective end surfaces of the positive electrode and the negative electrode face each other at a distance,
the positive electrode and the negative electrode are arranged in substantially the same plane,
the substrate fixingly supports the positive electrode and the negative electrode,
the electrolyte is present between the facing end surfaces of the positive electrode and the negative electrode,
the electrolyte is involved in a battery reaction between the positive electrode and the negative electrode, and
the electrolyte comprises ion conductive inorganic solid electrolyte particles and a liquid electrolyte component.

2. A method for manufacturing a nonaqueous secondary battery, the method comprising:
forming on a substrate a positive electrode and a negative electrode of which respective end surfaces face each other at a distance; and
filling a gap between the facing end surfaces of the positive electrode and the negative electrode with an electrolyte, the electrolyte being involved in a battery reaction between the positive electrode and the negative electrode,
wherein the electrolyte comprises ion conductive inorganic solid electrolyte particles and a liquid electrolyte component.

3. The method according to claim 2, wherein the positive electrode and the negative electrode are formed by:
forming a conductive layer on a surface of the substrate and patterning the conductive layer to thereby form a current collector;
applying a resist composition onto the surface of the substrate including the current collector to thereby form a resist layer;
irradiating the surface of the resist layer with light through a mask and developing the resist layer to thereby form a guide hole above the current collector; and
forming an active material layer on a surface of the current collector by using the guide hole as a casting mold, to thereby render the active material layer the positive electrode and the negative electrode.

4. An electrolyte comprising ion conductive inorganic solid electrolyte particles and a liquid electrolyte component.

5. The electrolyte according to claim 4, wherein the electrolyte is used in a nonaqueous secondary battery,
wherein the nonaqueous secondary battery comprises a positive electrode, a negative electrode, a substrate, and the electrolyte,
respective end surfaces of the positive electrode and the negative electrode face each other at a distance,
the positive electrode and the negative electrode are arranged in substantially the same plane,
the substrate fixingly supports the positive electrode and the negative electrode,
the electrolyte is present between the facing end surfaces of the positive electrode and the negative electrode, and
the electrolyte is involved in a battery reaction between the positive electrode and the negative electrode.
